(19) United States
(12) Patent Application Publication
(10) Pub. No.: US 2024/0143389 A1
(43) Pub. Date: May 2, 2024

(54) HIGH PERFORMANCE NODE-TO-NODE PROCESS MIGRATION

(71) Applicant: Nutanix, Inc., San Jose, CA (US)

(72) Inventors: Ivan TETEREVKOV, Ely (GB); Carl Alan WALDSPURGER, Palo Alto, CA (US); Jonathan DAVIES, Cambridge (GB)

(73) Assignee: Nutanix, Inc., San Jose, CA (US)

(21) Appl. No.: 17/976,596

(22) Filed: Oct. 28, 2022

(51) Int. Cl. G06F 9/48

(52) U.S. Cl. CPC G06F 9/4875; G06F 21/602

(57) ABSTRACT

Methods, systems, and computer program products for high-performance multi-node computing. Upon receiving a request to move a computing process from a first computing node to a second computing node, an agent responds to the request by: copying contents of one or more pages of the computing process from the first computing node to the second computing node, identifying page recency metadata corresponding to the one or more pages of the computing process, and copying all or portions of the identified page recency metadata to the second computing node. When the CPU of the second computing node accesses pages of the moved computing process, the operating system of the second computing node observes page recency metadata that had been copied from the first node and stored at the second computing node. The computing process might comprise a virtual machine, a guest operating system, or an executable container.

### TECHNICAL FIELD

This disclosure relates to multi-node computing systems, and more particularly to techniques for high performance node-to-node process migration.

### BACKGROUND

In computing settings involving virtual memory, when moving a computing entity (e.g., a computer process or a virtual machine or an executable container or other virtualized data item) from a source computing machine to a target computing machine, the contents of memory pages are moved from a source location to a target location. However, in computing settings involving virtual memory, the actual bits and bytes contents of the memory pages turns out to be not the only information that can be transferred from source to target when moving a computing entity.

Unfortunately, failing to recognize the existence and utility of all of the information that can be transferred from source to target when moving a computing entity leads to sub-optimal performance of the moved entity. Therefore, what is needed is a technique or techniques that address the foregoing deficiencies.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and in computer program products for high performance node-to-node process migration, which techniques advance the relevant technologies to address technological issues with legacy approaches. More specifically, the present disclosure describes techniques used in systems, methods, and in computer program products that perform virtual page cache recency metadata state cloning to achieve high performance node-to-node process migration. Certain embodiments are directed to technological solutions for transferring page recency metadata (e.g., information about pages and their corresponding recency) from the source node to a target node.

The disclosed embodiments modify and improve over legacy approaches. In particular, the herein-disclosed techniques provide technical solutions that address the technical problems attendant to achieving high performance inter-node process migration. Such technical solutions involve specific implementations (e.g., data organization, data communication paths, module-to-module interrelationships, etc.) that relate to the software arts for improving computer functionality. Various applications of the herein-disclosed improvements in computer functionality serve to reduce demand for computer memory, reduce demand for computer processing power, reduce network bandwidth usage, and reduce demand for intercomponent communication. For example, when performing computer operations that address the various technical problems underlying high performance inter-node process re-situation, both memory usage and CPU cycles demanded are significantly reduced as compared to the memory usage and CPU cycles that would be needed but for practice of the herein-disclosed techniques for transferring page recency metadata from a source node to a target node. This is because (1) the operating system (OS) on the target host will necessarily consume time and CPU resources needed to rebuild the page recency metadata, and (2) it often happens that, at least immediately after the pages of the guest process have been copied over to the target node, the active pages associated with the working set of the guest process are often non-optimally paged-out, which means that still further CPU cycles (e.g., for computing and for processing I/O to/from different memory tiers) would have to be expended to retrieve (e.g., from a slower, lower tier of memory) and page-in (e.g., to a faster, higher tier of) those active pages.

The ordered combination of steps of the embodiments serve in the context of practical applications that perform steps for transferring page recency metadata from the source node to a target node efficiently. As such, techniques for transferring page recency metadata from the source node to a target node overcome long-standing yet heretofore unsolved technological problems associated with achieving high performance of a migrated entity after the entity has been migrated from a source node to a target node.

Many of the herein-disclosed embodiments for transferring page recency metadata from the source node to a target node are technological solutions pertaining to technological problems that arise in the hardware and software arts that underlie computers and corresponding operating systems that support virtual memory abstractions. Aspects of the present disclosure achieve performance and other improvements in peripheral technical fields including, but not limited to, improvements pertaining to the design and configuration of tiered memory architectures, improvements pertaining to the design of high-performance operating systems, as well as improvements pertaining to cloud computing.

Some embodiments include a sequence of instructions that are stored on a non-transitory computer readable medium. Such a sequence of instructions, when stored in memory and executed by one or more processors, causes the one or more processors to perform a set of acts for transferring page recency metadata from the source node to a target node.

Some embodiments include the aforementioned sequence of instructions that are stored in a memory, which memory is interfaced to one or more processors such that the one or more processors can execute the sequence of instructions to cause the one or more processors to implement acts for transferring page recency metadata from the source node to a target node.

In various embodiments, any combinations of any of the above can be organized to perform any variation of acts for virtual page cache recency metadata state cloning, and many such combinations of aspects of the above elements are contemplated.

Further details of aspects, objectives and advantages of the technological embodiments are described herein, and in the figures and claims.

### BRIEF DESCRIPTION OF THE DRAWINGS

The drawings described below are for illustration purposes only. The drawings are not intended to limit the scope of the present disclosure.

FIG. 1A is a diagram that depicts a page recency migration technique as used in systems that communicate virtual page cache recency metadata state from a source machine to a target machine, according to an embodiment.

FIG. 1B1 depicts a page recency map as used in systems that communicate virtual page cache recency metadata state from a source machine to a target machine, according to an embodiment.

FIG. 1B2 depicts a two-queue page usage tracking data structure, according to an embodiment.

FIG. 1C1 is a page reference rate chart that characterizes a desired working set as a subset of a reference set of pages of a process, according to an embodiment.

FIG. 1C2 depicts a page reference rate chart where a high rate of references corresponds to a resident set and where a low rate of references corresponds to a paged-out set, according to an embodiment.

FIG. 1D1 depicts a naïve page transmission order, according to an embodiment.

FIG. 1D2 depicts a naïve LRU recency metadata structure that is populated based on naïve copying of pages from a source machine to a target machine, according to an embodiment.

FIG. 2 shows a page recency metadata handling technique as used in systems that implement virtual page cache recency metadata state cloning to achieve high performance node-to-node process migration, according to an embodiment.

FIG. 3A depicts a virtual machine migration scenario as implemented in a virtualization system that implements page cache recency metadata state cloning, according to an embodiment.

FIG. 3B depicts an executable container migration scenario as implemented in a system that implements page cache recency metadata state cloning, according to an embodiment.

FIG. 3C depicts an example multi-node computing cluster that hosts migration agents within respective virtualized controllers at each of the multiple nodes, according to an embodiment.

FIG. 4 depicts a page data transmission technique as implemented in systems that handle page cache recency metadata to achieve high performance node-to-node computing entity migration, according to an embodiment.

FIG. 5 depicts a page recency metadata transmission technique as implemented in systems that communicate virtual page cache recency metadata state between a source node and a target node, according to an embodiment.

FIG. 6A, FIG. 6B, and FIG. 6C depict page recency metadata handling techniques as implemented in systems that communicate virtual page cache recency metadata state between a source node and a target node, according to an embodiment.

FIG. 7 depicts a selection of queue management functions as used in a caching subsystem, according to an embodiment.

FIG. 8A and FIG. 8B depict alternative page recency transfer protocols, according to an embodiment.

FIG. 9A, FIG. 9B, FIG. 9C, and FIG. 9D depict virtualization system architectures comprising collections of interconnected components suitable for implementing embodiments of the present disclosure and/or for use in the herein-described environments.

### DETAILED DESCRIPTION

Aspects of the present disclosure solve problems associated with using computer systems for achieving high performance inter-node process re-situation. These problems are unique to various computer-implemented methods for achieving high performance inter-node process re-situation in the context of multi-node computing platforms. Some embodiments are directed to approaches for transferring page recency metadata from the source node to a target node. The accompanying figures and discussions herein present example environments, systems, methods, and computer program products for implementing virtual page cache recency metadata state cloning to achieve high performance node-to-node process migration.

### Overview

Modern system software such as operating systems and hypervisors support virtual memory. Some of these operating systems and hypervisors additionally track the “recency” of evictable page frames so as to facilitate efficient memory (e.g., cache memory, high-speed memory) use and reclamation. This tracking of the “recency” of evictable page frames helps improve reclamation choices under memory pressure. For example, an operating system kernel can be configured such that the most actively used page frames remain mapped to faster memory, such as a page cache in RAM, and the least actively used page frames become reclamation targets (e.g., to release page frames from faster memory back into lower tiers of slower memory). Basing eviction decisions on per-page activity information helps preserve the “hot” working set of a process, and thereby increases overall responsiveness by avoiding page faults that would cause scheduling and subsequent performance of I/O operations involving lower tiers of memory.

Some operating system kernels maintain separate “active” and “inactive” least recently used (LRU) lists for page frames. In this regime, the “recency” of the given page frame is expressed by the page's membership in a particular list (as well as its position in the list and/or a timestamp characterizing the time of the most recent access). The head of the “active” page LRU list is the most recently used page frame, and the tail of the “inactive” page LRU list is the least recently used page frame.

Some operating system kernels implement a multi-generational (MGLRU) regime that augments the concepts of the aforementioned “active” and “inactive” page LRU lists with a plurality of LRU lists that are organized so as to further improve reclamation choices. Each LRU list in this MGLRU regime is associated with a timeframe. Strictly as an example, if a page frame is placed on the “hot” list, it means it has been accessed within a pre-defined absolute time interval associated with the “hot” list. Each mapped frame has additional associated metadata indicating how actively it's being accessed, and this information can be used to characterize the dynamic nature of a process's working set.

Different operating system kernels and/or hypervisors implement a range of page replacement/caching algorithms involving one or both of observed most recent page access information, and/or from observed page access frequency information, or derived from any other sort of page access information. Some LRU-based algorithms (LRU algorithms) use only recency information. Some other algorithms such as “Least Frequently Used” (LFU algorithms) use only frequency information. Still other algorithms such as “Adaptive Replacement Cache” (ARC algorithms), or such as the “Low Inter-reference Recency Set replacement” (LIRS algorithms), or such as the “Least Recently/Frequently Used” (LRFU algorithm) all use a combination of recency information and frequency information to make eviction decisions for managing “hot” and “cold” pages under the constraints of limited memory availability.

The above techniques (e.g., for managing “hot” and “cold” pages) can be used in both virtualized and non-virtualized systems. In non-virtualized systems involving multiple nodes, a computing process can be moved from a source node to a target node, and in the event that the herein-disclosed techniques are used, the process at the target node can avail itself of then-current page recency information. In virtualized systems, the above techniques apply to both the host OS of the virtualization system as well as to the guest OS of the virtualization system. Whenever the memory allocated to a virtual machine becomes subjected to memory pressure, the above techniques can be used. More specifically, the above techniques can be advantageously applied when performing live migration of a virtual machine from one node to another node.

As used herein, a computing process is any sequence of executable instructions that access (e.g., to READ from, or to WRITE to, or to EXECUTE) any code or data that is organized into a plurality of pages. In some cases, such a sequence of executable instructions includes an entry point (e.g., a first executable instruction of the sequence). Such a sequence of executable instructions may be subsumed into a named entity, and/or into a virtual machine of a virtualization system, and/or into a guest operating system of a virtualization system, and/or into an executable container. A computing process can be moved, or re-situated, or migrated from a source node to a target node.

Movement, or re-situation, or migration of a computing process involves transferring memory contents of the computing process from a source host to a target host. Unfortunately, legacy movement, or re-situation, or migration techniques do not transfer any page recency metadata (e.g., page membership in the “active” and “inactive” or MGLRU lists). Consequently, in accordance with legacy implementations, after movement, or re-situation, or migration of the computing process, the target host executes the moved, or re-situated, or migrated computing process in spite of the fact that neither the target node's host OS nor the target node's hypervisor has accurate page recency metadata for page frames of the moved, or re-situated, or migrated computing process. Instead, in absence of copying page recency metadata from the source node to the target node, the page recency metadata at the target node merely corresponds to the order in which specific pages were transferred during the migration. In most cases, the order in which specific pages were transferred during the movement, or re-situation, or migration (e.g., merely in an ascending page address or page index order) is not indicative of the hottest (or coldest) pages of the subject computing process. To further explain, even though a detailed accounting of “hot” pages and “cold” pages had been captured and were known at the source node, unless such page recency metadata is copied to the target node, the target node is forced to make keep/evict decisions based on page recency metadata that is not indicative of the actual hotness or coldness of the pages with respect to prior execution of the computing process.

As can now be understood, execution of the moved, or re-situated, or migrated process in absence of up-to-date page recency metadata of the moved, or re-situated, or migrated process is bound to be inefficient due to at least two phenomena: First, the operating system kernel on the target host will necessarily consume time and CPU resources needed to rebuild the page recency metadata (e.g., LRU lists) associated with the computing process. Secondly, it often happens that, at least immediately after the pages of the computing process have been copied over to the target node, the “active” pages associated with the process's working set are often non-optimally paged out. As such, metadata-poor reclamation decisions by the kernel can cause extreme performance degradation, such as thrashing to/from the host swap space. The impact of thrashing (e.g., performance degradation) becomes more and more acute as the computing process size becomes larger and/or when there is high memory pressure on the target.

Further, this unwanted impact will persist until such time as the page recency information has been brought up to date as a result of ongoing actual execution of the computing process. This thrashing can adversely impact the overall performance of not only the computing process at the target, but also, this thrashing can adversely impact the overall performance of other processes or virtual machines or executable containers on the target machine. Depending on the size of the target computer's memory, these unwanted non-optimal paging decisions and the effects therefrom may persist for minutes, or tens of minutes, or even longer (e.g., for very large processes), until such time as the page recency information has been brought up to date with respect to the actual execution status of the computing process at the target node.

Techniques for handling processes (e.g., as in the heretofore discussed examples) can be applied to movement of any sorts of computing entities that execute in a virtual memory regime. In some settings, virtual machines of a virtualization system and/or non-virtualized executable containers can be migrated together with their respective page recency metadata.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

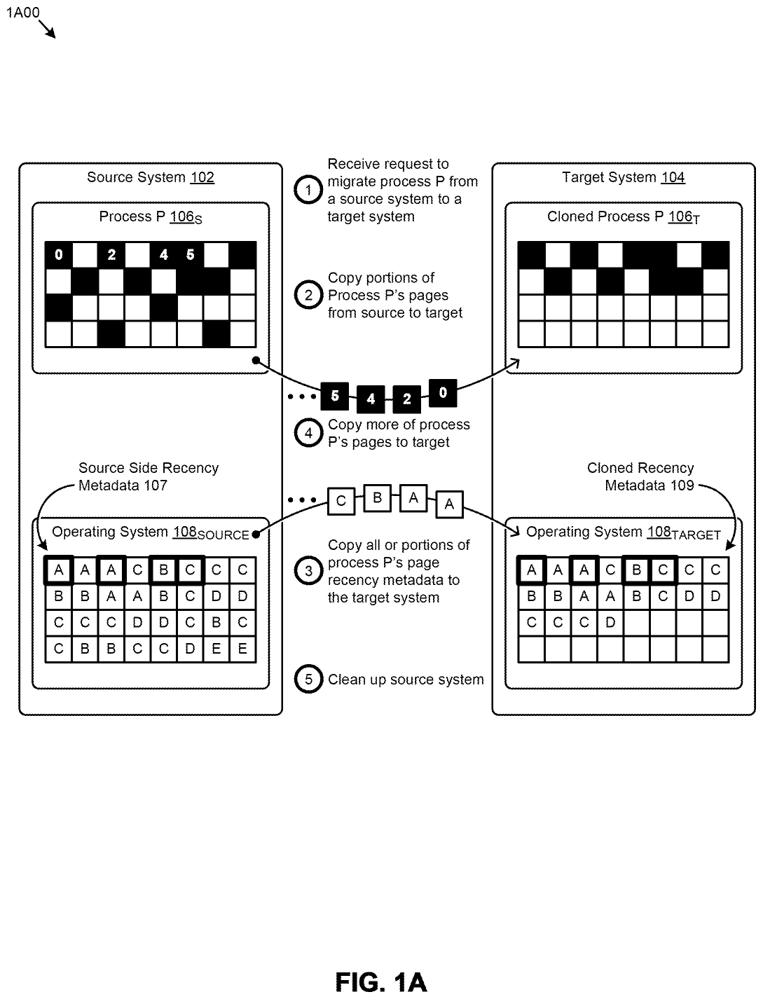

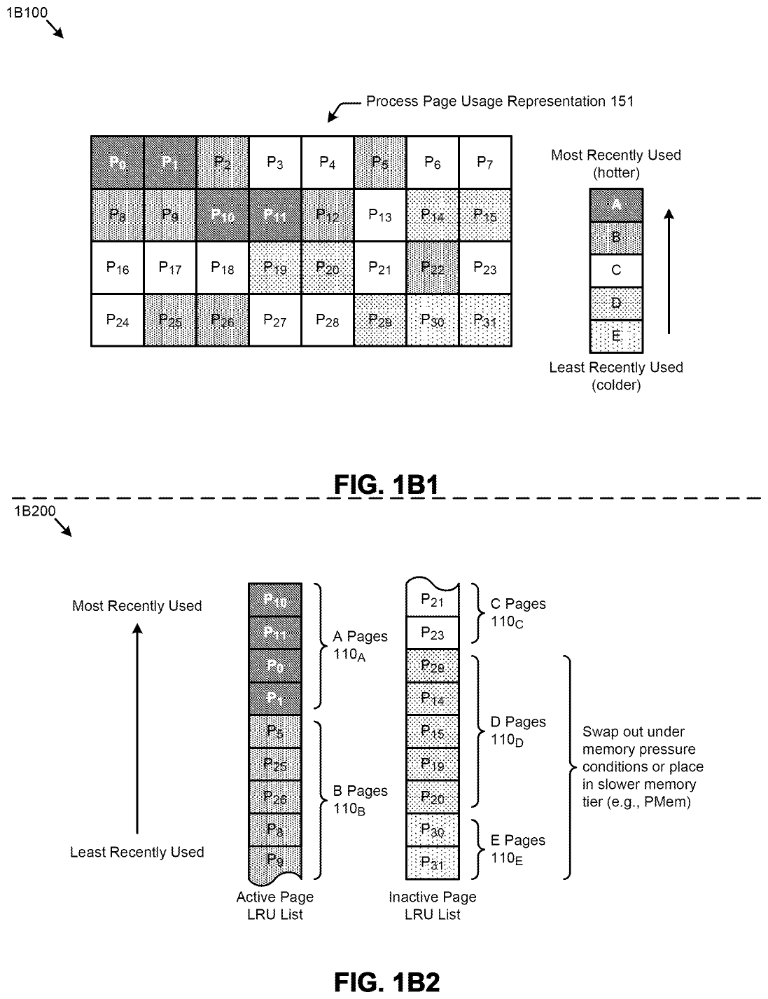

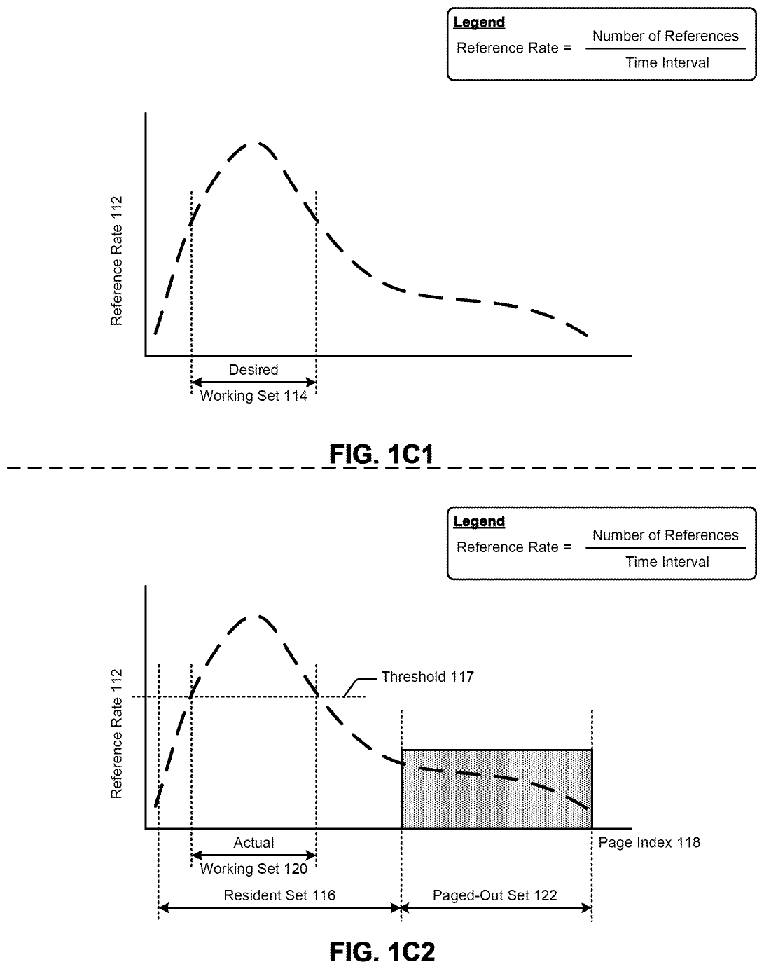

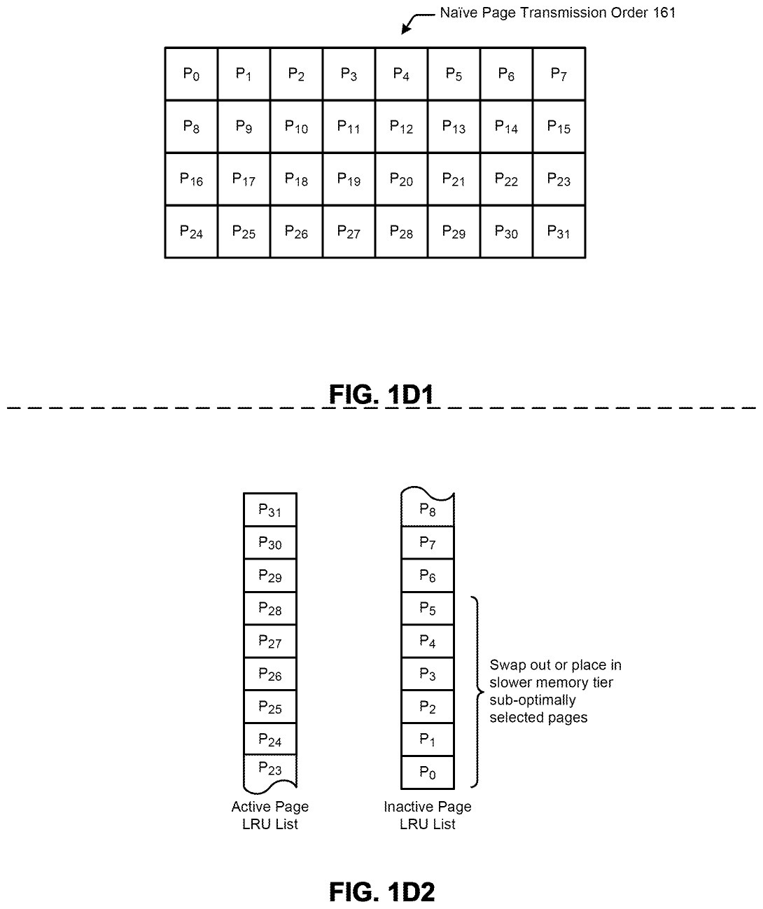

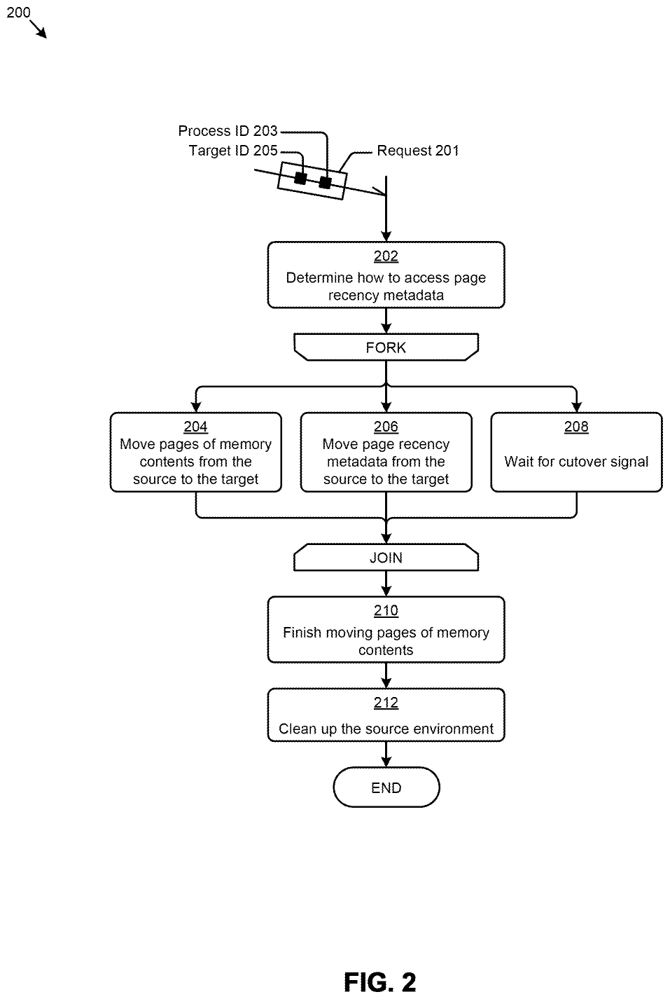

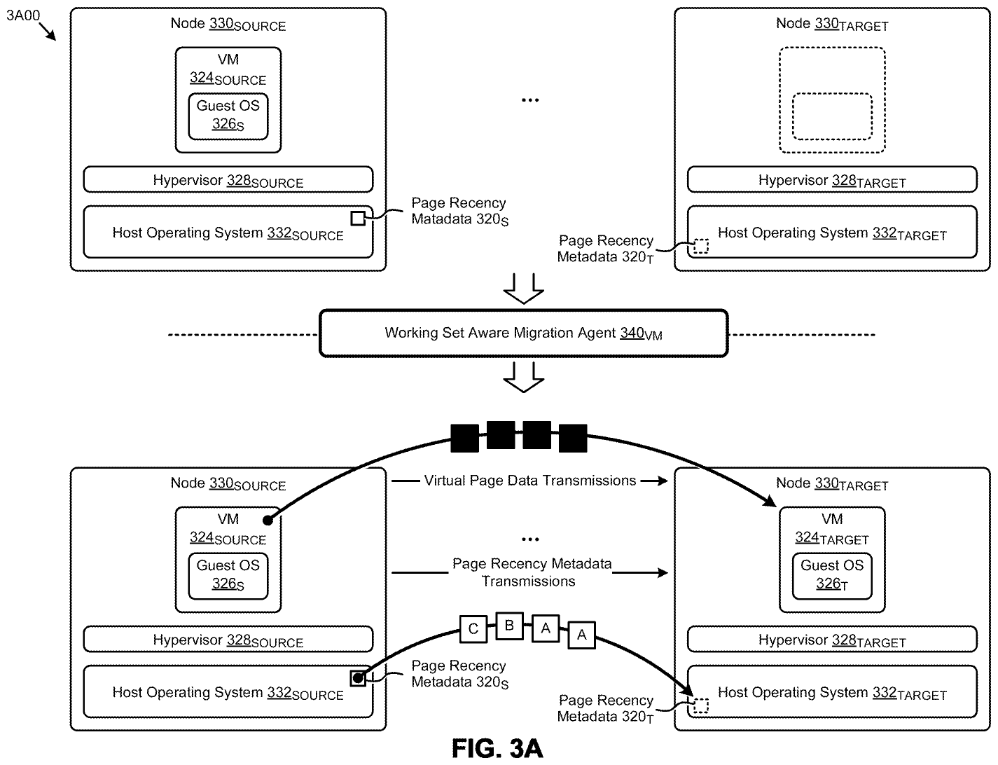

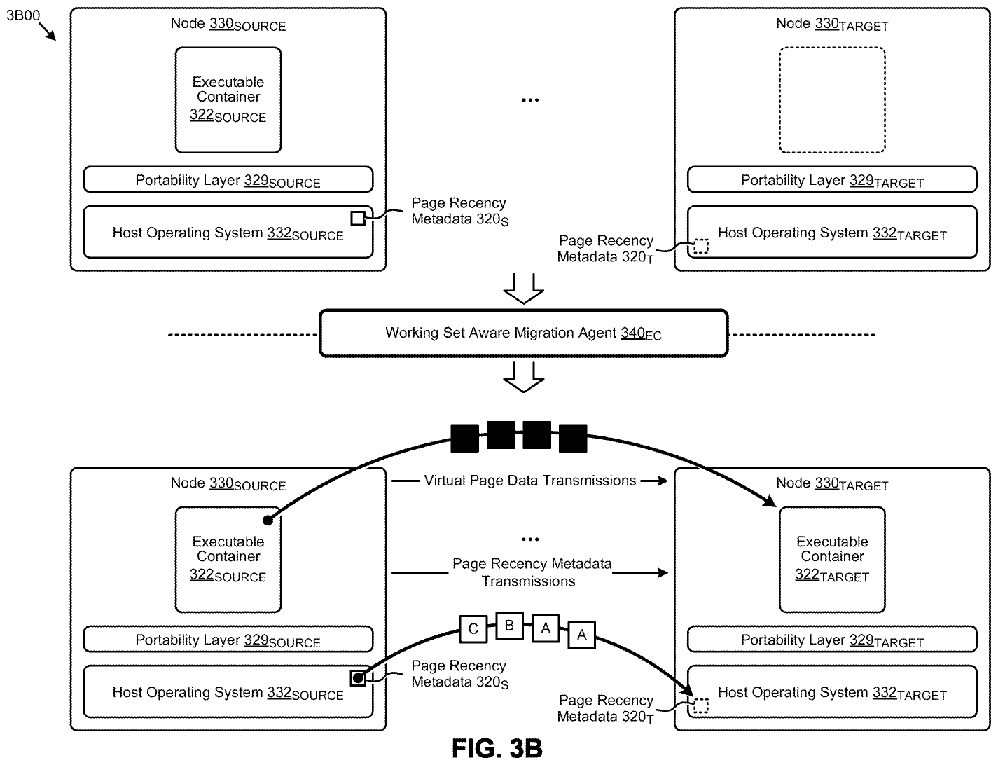

FIG. 1A is a diagram that depicts a page recency migration technique as used in systems that communicate virtual page cache recency metadata state from a source machine to a target machine. As an option, one or more variations of page recency migration technique 1A00 or any aspect thereof may be implemented in the context of the architecture and functionality of the embodiments described herein and/or in any environment.

The figure is being presented to illustrate the basic operation of communicating (e.g., transmitting, copying, migrating) virtual page data and corresponding page recency metadata from a source computing system (e.g., source system 102) to a target computing system (e.g., target system 104).

As shown, the acts of communicating page data and corresponding page recency metadata from a source computing system to a target computing system can be triggered when a request to migrate a process (operation 1) is raised. The request can be initially handled by either the source system or the target system. On the case of the source system being the initial responder to the request, any computing entity of the source system (e.g., the operating system of the source system, a hypervisor of the source system, a kernel agent or ancillary control processor, etc.) can respond to the request by (1) copying certain pages of the to-be-migrated process (e.g., process P 106_{S}) to the target system as well as (2) copying the to-be-migrated processes page recency metadata (e.g., source side recency metadata 107 of operating system 108_{SOURCE}) to the target system.

As shown, it can happen that, initially, only portions of the bits and bytes of the process's virtual pages are copied from the source system to the target system (operation 2). The act of copying pages from the source system to the target system affects page recency metadata. Correspondingly, it can happen that only portions of the process's page recency metadata are copied from the source system to the target system (operation 3).

When a particular subset of virtual pages of running process P has been copied over to the target system, a cutover signal cause the target system to begin executing the cloned process P 106T. Since the page recency metadata for running process P has been copied from the source system to the target system, the operating system 108_{TARGET} has sufficient information to make the same eviction decisions as would have been made by the source system under the same memory size and memory pressure conditions.

At some point in time, more or all of the virtual pages of process P (operation 4) and more or all of the page recency metadata corresponding to those virtual pages will have been copied to the target system. At that point in time, since the needed virtual pages of process P and page recency metadata corresponding to those virtual pages (e.g., cloned recency metadata 109) have been copied to the target system, the cloned process P 106_{T} can run without demanding pages from the source system. Furthermore, since neither the virtual pages of process P 106_{S} nor the source side recency metadata 107 are current, the virtual pages of process P 106_{S} and the source side recency metadata 107 can be destroyed or otherwise cleaned up (operation 5).

The foregoing example illustrates a simplified page recency model involving two designations of page recency (i.e., “hot” pages and “cold” pages) that are managed in a two-tier memory hierarchy. However, there are many other models that provide more fine-grained designations of virtual pages. One example technique using a page recency map involving multiple-grained designations of virtual pages is shown and described as pertains to FIG. 1B1.

FIG. 1B1 depicts a page recency map as used in systems that communicate virtual page cache recency metadata state from a source machine to a target machine. As an option, one or more variations of page recency map 1B100 or any aspect thereof may be implemented in the context of the architecture and functionality of the embodiments described herein and/or in any environment.

The figure is being presented to illustrate how individual ones of a set of virtual pages of a process (e.g., page P0 through page P31 of the shown process page usage representation 151) can be individually tagged in accordance with a five-level designation regime. As shown, designation ‘A’ and designation ‘B’ correspond to the two hottest levels (e.g., most recently used levels), whereas designation ‘C’, designation ‘D’, and designation ‘E’ correspond to the three lowest levels (e.g., least recently used levels). The multiple designations might correspond to a tier of a multi-tiered memory architecture. Page references, together with their designations, are manipulated with respect to those multiple tiers of memory. One example technique involving manipulation of multiple lists and multiple-grained designations of virtual pages is shown and described as pertains to FIG. 1B2.

FIG. 1B2 depicts a two-queue page usage tracking data structure. As an option, one or more variations of least recently used page tracking data structure 1B200 or any aspect thereof may be implemented in the context of the architecture and functionality of the embodiments described herein and/or in any environment.

As a process executes, the kernel and/or other agents manipulate one or more lists of pages. In this embodiment, there are two lists (1) the active page LRU list, and (2) the inactive page LRU list. Entries are manipulated between these lists such that entries for the hottest or hotter pages (e.g., A pages 110A and B pages 110B) are stored in the active page LRU list, whereas entries for the cool, cooler, and coldest pages (e.g., C pages 110, D pages 110, and E pages 110E) are stored in an inactive page LRU list. A particular page may be assigned a designation (e.g., ‘A’, ‘B’, ‘C’, etc.) based on an amount of time since a most recent access. For example, pages that have been accessed two or more times within a recent 10 millisecond window are designated as ‘A’ pages, whereas pages that have been accessed less frequently, say within a recent 30 millisecond window, are designated as ‘B’ pages, and so on. Pages that have not been accessed within a longer time window such as 500 milliseconds or longer are designated as ‘C’ or ‘D’ or ‘E’ pages and are found in the inactive page LRU list. In the event of memory pressure where there are more virtual page frames being accessed than there is memory frame space, then pages with ‘E’ or ‘D’ designations are swapped out to a lower tier of memory in favor of an incoming page or page frame.

The foregoing describes how a multi-tier memory architecture can be configured so as to keep the hottest pages in the highest tier of memory, while keeping a list of pages that are the best-known candidates for releasing in the event of memory pressure.

Presently, desired behavior of a caching system is described. In particular, FIG. 1C1 and FIG. 1C2 show desired behaviors of a caching system based on a reference rate of page accesses.

FIG. 1C1 is a page reference rate chart that characterizes a desired working set as a subset of a reference set of pages of a process. As depicted, the desired working set 114 corresponds to the pages that have the highest reference rate 112 (i.e., the most frequently accessed pages). Other pages that have lower reference rates are at least candidates for being swapped out so as to allow for CPU access to other pages. More specifically, those pages that are part of a resident set, but are not being accessed frequently can be paged out. This is shown in FIG. 1C2.

More specifically, FIG. 1C2 depicts a page reference rate chart where a high rate of references corresponds to a resident set 116 and where a low rate of references corresponds to a paged-out set 122. In this example, the actual working set 120 corresponds to those pages that are being accessed at a frequency at least as high as threshold 117. Strictly for illustration, this example is contrived such that those pages that are being accessed at a frequency at least as high as threshold 117 are in a contiguous range that correspond to a relatively low range of page indexes 118, whereas those pages that are being accessed at a frequency much lower than threshold 117 are in a contiguous range that corresponds to a relatively high range of page indexes.

Frequently accessed pages need not be contiguous with respect to each other. In actual practice, it often happens that the most frequently accessed pages are distributed throughout the full range of the addresses of the virtual pages.

Now, with an understanding of how a paging system operates under normal operating conditions, it becomes apparent that, in absence of the herein-disclosed techniques for cloning page recency metadata when migrating a process, the caching subsystem of a target would be initialized to be almost certainly completely wrong at the moments during and after the process has been cloned from a source node to a destination node. Although it is possible to move the pages from source to target in some hottest-first regime, it is nevertheless instructive to show how a naïve process cloning technique would almost certainly be initialized to be completely wrong during the entire time that the process is being cloned from a source node to a destination node.

The disclosed approaches consider the fact that pages must be accessed in order to transfer their data during live migration. These accesses during live migrations have the potential to “mangle” page recency metadata on the source host, at least because reading a “cold” (i.e., not recently accessed) page to transfer its data to the target will make the page appear to be “hot” (recently accessed), even though it wasn't actually accessed by the entity being migrated, but rather by the software that implements the migration. To address this, some implementations capture page recency metadata prior to the migration. Other embodiments implement migration software that can avoid such mangling, such as by restoring page recency metadata state incrementally (e.g., by restoring page recency metadata to a correct state just before accessing a migrated page).

One instructive example is shown as described as pertains to FIG. 1D1 and FIG. 1D2. Specifically, FIG. 1D1 depicts a naïve page transmission order and FIG. 1D2 depicts a naïve LRU recency metadata structure that is populated based on naïve copying of pages from a source machine to a target machine. The shown naïve transmission order 161 increments from the lowest numbered page (page P0) through the highest numbered page (page P31). Accordingly, the most recently used page is page P31 and the least recently used page is page P0. This strongly undesirable situation arises in absence of the herein-disclosed page recency cloning techniques. This situation is strongly undesirable since, in absence of the herein-disclosed page recency cloning techniques, correct, up-to-date page recency metadata would need to be re-constructed at the target node even though there exists correct, up-to-date page recency metadata state at the source node.

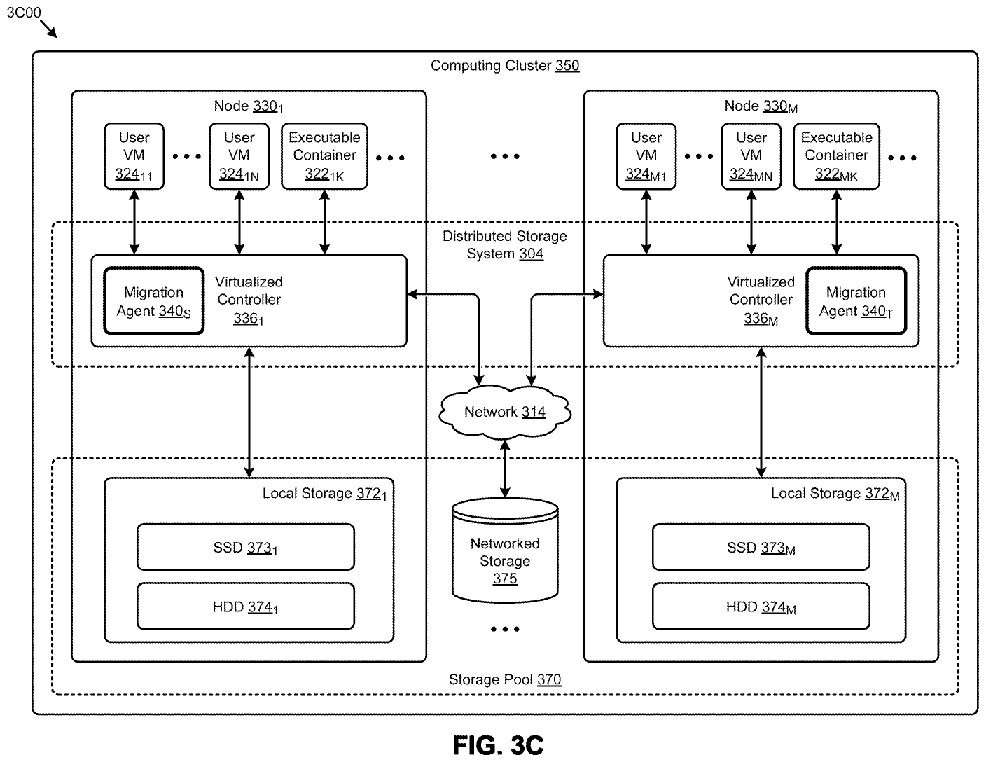

FIG. 2 shows a page recency metadata handling technique as used in systems that implement virtual page cache recency metadata state cloning to achieve high performance node-to-node process migration. As an option, one or more variations of page recency metadata handling technique 200 or any aspect thereof may be implemented in the context of the architecture and functionality of the embodiments described herein and/or in any environment.

The figure is being presented to illustrate one possible implementation of the operations (e.g., operation 1, operation 2, operation 3, operation 4, and operation 5) as shown and described as pertains to FIG. 1A. More specifically, the figure is being presented to illustrate how cloning of the data of virtual pages can be carried out asynchronously with cloning of page recency metadata.

A request to migrate a process from a source node to a target node is received at some moment in time. This is shown as request 201 that appears at the top of the flowchart. The request includes information about the process to be migrated (e.g., process ID 203) as well as a designation of the intended target node (e.g., target ID 205). The occurrence of this event invokes processing to determine how to access page recency metadata for the referenced process (step 202). In some cases, page recency metadata is stored in, or in association with, page tables and/or in, or in association with, a translation lookaside buffer. In some cases, one or more application programming interfaces (APIs) can be accessed to retrieve page recency metadata.

Now, having both the mechanism to retrieve page recency metadata as well as the mechanism to access the contents of the virtual pages of the referenced process, cloning is initiated. In this embodiment, three independently executing tasks are kicked off in a FORK JOIN block. The three tasks are configured to (1) move pages of memory contents (step 204) from the source to the target, (2) move page recency metadata (step 206) from the source to the target, and (3) wait (step 208) for a cutover signal. The movement of the contents of virtual pages can include transmitting all or merely portions of the contents of virtual pages of the subject process. Further, the movement of the page recency metadata can include transmitting all or merely portions of page recency metadata of the subject process. In some cases, movement of the contents of virtual pages is interleaved with movement of page recency metadata.

At some moment in time, control logic of the multi-node computing platform indicates conditions for a cutover (e.g., a cutover from executing the subject process on the source to executing the cloned subject process on the target). There are many possible cutover situations. In some situations, a cutover doesn't occur until all pages of the subject process have been cloned at the target. In other situations, it is possible to cut over as soon as there is a critical subset (e.g., a working set) of virtual pages of the subject process existing at the target. In some situations, such as when CXL.memory operations are supported (e.g., over PCI-e), a cutover can occur in a very early phase of the migration, such as when at least one page of executable code has been cloned to the target. Thereafter, execution of the process at the target will cause page faults at the target, which page faults are satisfied by moving virtual page contents from the source to the target using the CXL.memory protocol.

Further details regarding general approaches to migration and cutover using the CXL.memory protocol are described in U.S. application Ser. No. 17/710,342 titled “VIRTUAL MACHINE REMOTE HOST MEMORY ACCESSES” filed on Mar. 31, 2022, which is hereby incorporated by reference in its entirety.

In many cases, such as is depicted in FIG. 2, at least some of the pages of virtual memory remain to be cloned over to the target even after occurrence of the cutover signal. This situation is handled in the flow of FIG. 2 at step 210. Specifically, operations of step 210 are configured to finish moving pages of virtual memory of the subject process from the source node to the target node. Moving pages of virtual memory of the process from the source node to the target node can take place even after occurrence of the cutover signal. When all pages of virtual memory of the process have been cloned from the source node to the target node, or at least when it is deemed that no further pages need to be cloned from the source node to the target node, then the data of those pages can be destroyed (e.g., in the clean-up activities of step 212).

Any/all of the functions underlying performance of any of the steps of FIG. 2 can be implemented in any convenient location in the code base of the computing platforms. That is, implementation of some functions and/or features might be implemented in whole or in part within the kernel, whereas other functions would most likely need to be in modules apart from the kernel.

Strictly as one example of modules apart from the kernel, consider the software stack of a virtualization system. Given the interoperation of modules of a virtualization system, it would be possible to situate all or some functions and/or features wholly or in part within any of (1) a hypervisor, (2) a host operating system or subordinate module thereof, (3) a migration agent, (4) a controller virtual machine, or (5) any other executable code of the computing platform.

In some embodiments, a first migration agent is situated on the source node and a second migration agent is situated on the target node. The first and second migration agents cooperate during migration. In some cases, such cooperation involves copying of page data and recency metadata over a network that interconnects the target node to the source node (and vice-versa).

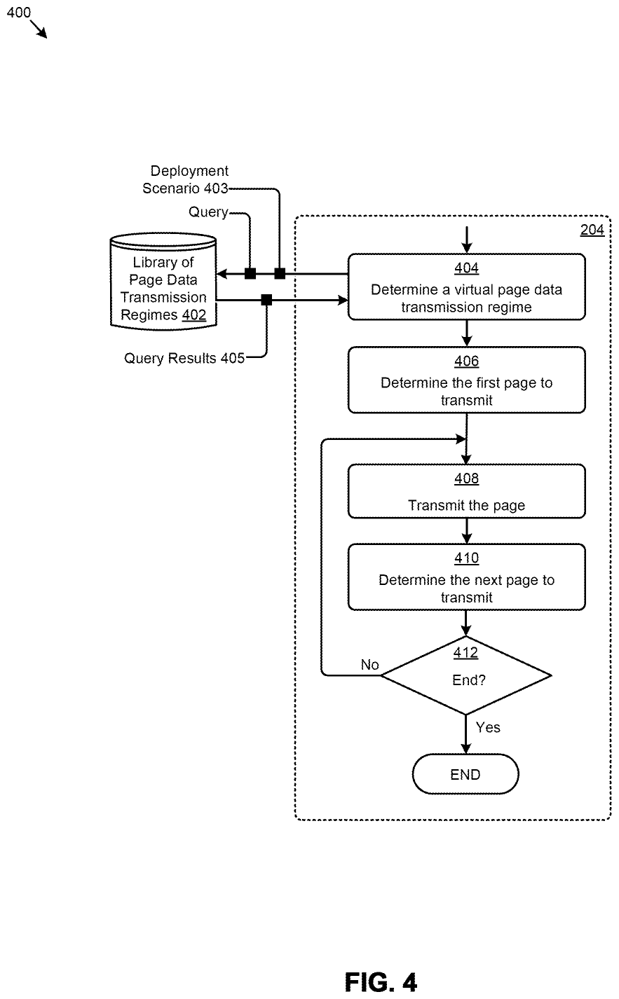

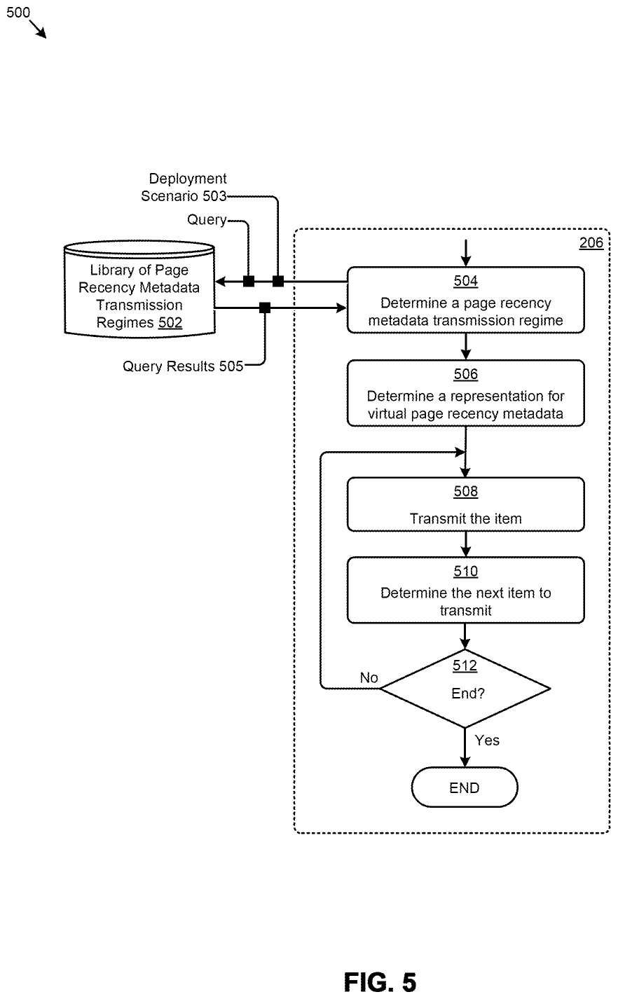

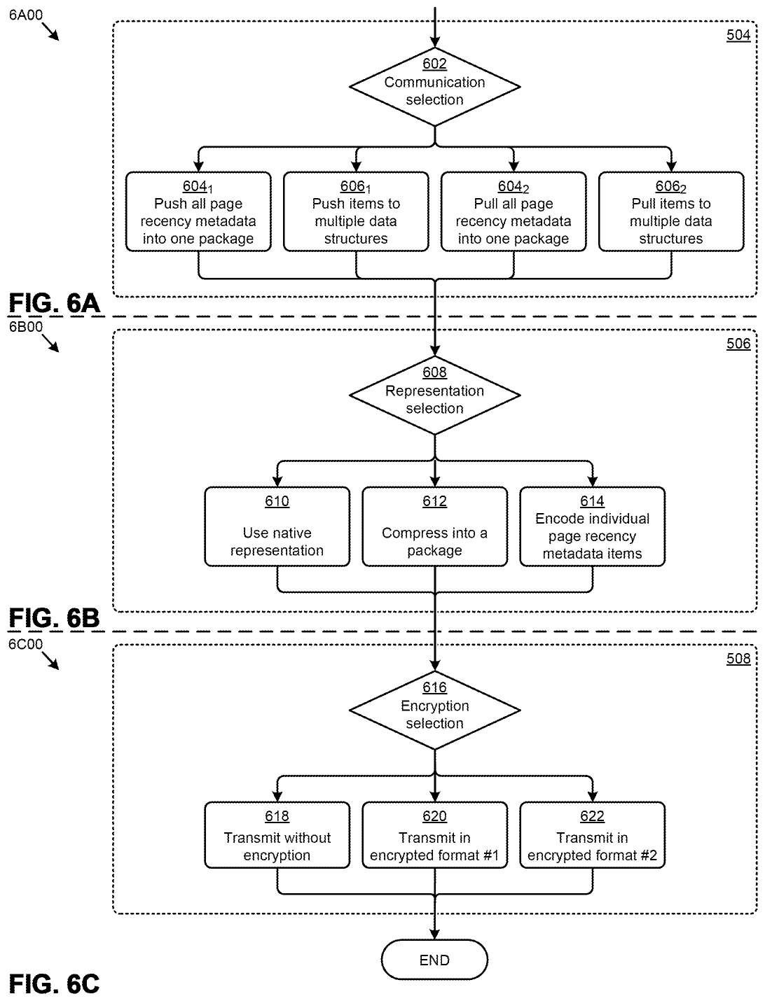

In an alternative embodiment, a single migration agent is provided. Such a migration agent is able to access (e.g., read and/or write) data of both the source node and the target node. In some implementations, a migration agent is situated in a virtualization system and is configured to be able to clone contents of virtual pages of a virtual machine as well as corresponding page recency metadata. FIG. 3A depicts such an implementation. Moreover FIG. 3A depicts the scenario where a migration agent is used to clone a virtual machine, including its data state and its page recency metadata state.

FIG. 3A depicts a virtual machine migration scenario as implemented in a virtualization system that implements page cache recency metadata state cloning. As an option, one or more variations of virtual machine migration scenario 3A00 or any aspect thereof may be implemented in the context of the architecture and functionality of the embodiments described herein and/or in any environment.

The figure is being presented to illustrate an example use case where a virtual machine is being migrated from a source node (e.g., the shown node 330_{SOURCE}) to a target node (e.g., node 330_{TARGET}). The top portion of this figure depicts the migration plan, specifically, that a virtual machine on the source node (e.g., VM 324_{SOURCE}) is to be migrated to the target node (e.g., as depicted by the dotted lines above hypervisor 328_{TARGET}). In this example computing cluster, a host operating system as well as various components of a virtualization system are situated at each node. More specifically, configuration of the source node includes a host operating system (e.g., host operating system 332_{SOURCE}), a virtualization system hypervisor (e.g., hypervisor 328_{SOURCE}) as well as a virtual machine that includes a guest operating system (e.g., guest OS 326_{S}). In some situations, such as in Linux-based systems, the host OS and hypervisor are the same entity; that is, the host OS has sufficient native code so as to be able to act as a virtualization system hypervisor.

The target node is similarly configured. Specifically, configuration of the target node includes a host operating system (e.g., host operating system 332_{TARGET}), a virtualization system hypervisor (e.g., hypervisor 328_{TARGET}), as well as sufficient resources to host a virtual machine that includes a guest operating system. The depicted scenario shows the existence of page recency metadata 320_{S} for a particular computing process as being situated in host operating system 332_{SOURCE}. The depicted scenario further shows that, initially, there is no page recency metadata 320T for the particular computing process at the target node (although there may be page recency information belonging to other processes running at the target node).

In this example use case, a working set aware migration agent 340_{VM} facilitates a sequence of virtual page data transmissions from the source node to the target node. Further, working set aware migration agent 340_{VM} facilitates a sequence of page recency metadata transmissions from the source node to the target node. In this specific example, all page recency metadata corresponding to ‘A’ pages of the virtual machine are transmitted before any page recency metadata for ‘B’ pages of the virtual machine are transmitted, and all page recency metadata corresponding to ‘B’ pages of the virtual machine are transmitted before any page recency metadata for ‘C’ pages of the virtual machine are transmitted.

The depicted scenario shows the existence of page recency metadata 320_{S} as being communicated to host operating system 332_{TARGET}, after which guest OS 326T and any of its processes corresponding to the now available page recency metadata (e.g., VM 324_{TARGET}) are able to execute with the benefit of the page recency metadata 320T that was transferred from the host operating system 332_{SOURCE}.

The foregoing example pertains to scenarios involving virtual machines in a virtualization environment, however the herein-disclosed techniques can be advantageously applied in scenarios involving executable containers.

FIG. 3B depicts an executable container migration scenario as implemented in a system that implements page cache recency metadata state cloning. As an option, one or more variations of executable container migration scenario 3B00 or any aspect thereof may be implemented in the context of the architecture and functionality of the embodiments described herein and/or in any environment.

The figure is being presented to illustrate an example use case where an executable container is being migrated from a source node (e.g., the shown node 330_{SOURCE}) to a target node (e.g., node 330_{TARGET}). The top portion of this figure depicts the migration plan, specifically, that an executable container on the source node (e.g., executable container 322_{SOURCE}) is to be migrated to the target node (e.g., as depicted by the dotted lines above portability layer 329_{TARGET}). In this example computing cluster, a host operating system as well as a container resource layer are situated at each node. More specifically, configuration of the source node includes an operating system (e.g., host operating system 332_{SOURCE}) and a container resource layer (e.g., portability layer 329_{SOURCE}). The target node is similarly configured. Specifically, configuration of the target node includes an operating system (e.g., host operating system 332_{TARGET}) and a container resource layer (e.g., portability layer 329_{TARGET}). The depicted scenario shows the existence of page recency metadata 320_{S} as being situated in host operating system 332_{SOURCE}. The depicted scenario further shows that, initially, there is no page recency metadata 320T at the target node.

In this example use case, a working set aware migration agent 340_{EC} facilitates a sequence of virtual page data transmissions from the source node to the target node. The working set aware migration agent 340_{EC} can be configured differently from working set aware migration agent 340_{VM} so as to handle differences between virtual machine migrations and executable container migrations. As shown, the working set aware migration agent 340_{EC} facilitates a sequence of page recency metadata transmissions from the source node to the target node. In this specific example, all page recency metadata corresponding to ‘A’ pages of the executable container are transmitted before any page recency metadata for ‘B’ pages of the executable container is transmitted, and all page recency metadata corresponding to ‘B’ pages of the executable container are transmitted before any page recency metadata for ‘C’ pages of the executable container is transmitted.

The depicted scenario shows the existence of page recency metadata 320_{S} as being communicated to host operating system 332_{TARGET}, after which executable container 322_{TARGET} is able to execute with the benefit of the page recency metadata 320T that was transferred from the host operating system 332_{SOURCE}.

Mixing Virtual Machines with Executable Containers

In some cases, both a working set aware migration agent 340_{VM} as well as a working set aware migration agent 340_{EC} can be deployed to operate cooperatively on any particular one or more computing nodes. In some cases, the facilities of a working set aware migration agent 340_{VM} can be combined with the facilities of a working set aware migration agent 340_{EC}. The resulting working set aware migration agent can in turn be deployed onto any particular one or more computing nodes of a multi-node computing cluster. Such a deployment is shown and described as pertains to FIG. 3C.

FIG. 3C depicts an example multi-node computing cluster that hosts migration agents within respective virtualized controllers at each of the multiple nodes. As an option, one or more variations of computing cluster 350 or any aspect thereof may be implemented in the context of the architecture and functionality of the embodiments described herein and/or in any environment.

The figure is being presented to illustrate how the herein-disclosed techniques for handling page recency metadata can be applied in a virtualized multi-node computing cluster. An example virtualized multi-node computing cluster and brief discussions of various configurations are presented hereunder.

The environment 3C00 shows various components associated with one instance of a distributed storage system 304 that can avail of the herein disclosed techniques. Specifically, the environment 3C00 comprises multiple nodes (e.g., node 330₁, . . . , node 330_{M}) that each access multiple tiers of storage in a storage pool 370. For example, each node can be associated with one server, multiple servers, or portions of a server. A group of such nodes can be called a cluster. The multiple tiers of storage can include storage that is accessible through the network 314 such as a networked storage 375 (e.g., storage area network or SAN, network attached storage or NAS, etc.). Storage pool 370 can also comprise one or more instances of local storage (e.g., local storage 372₁, . . . , local storage 372_{M}) that is within or directly attached to a server and/or appliance associated with the nodes. Such local storage can include solid state drives (SSD 373₁, . . . , SSD 373_{M}), hard disk drives (HDD 374₁, . . . , HDD 374_{M}), and/or other storage devices.

Each node can implement at least one instance of a virtualized controller (e.g., virtualized controller 336₁, . . . , virtualized controller 336_{M}) to facilitate access to the storage pool 370 by one or more user virtual machines (e.g., user VM 324₁₁, . . . , user VM 324_{IN}; user VM 324_{M1}, . . . , user VM 324_{MN}). The hardware of the node can be emulated for the user VMs by various hypervisors. For example, such hypervisors can be implemented using virtualization software (e.g., VMware ESXi, Microsoft Hyper-V, RedHat KVM, Nutanix AHV, etc.) that includes a hypervisor. Multiple instances of such virtualized controllers can coordinate within a cluster to form a distributed storage system 304 which can, among other operations, manage aspects of storage pool 370. This architecture further facilitates deployment of node-specific migration agents (e.g., working set aware migration agent 340_{S} and working set aware migration agent 340T).

As earlier described, the user VMs can run certain client software such as applications (e.g., guest applications running within the VMs) that might interact with the virtualized controllers to access data in the storage pool 370. Any of the nodes can also facilitate executable application containers (e.g., executable container 322_{1K}, . . . , executable container 322_{MK}) implemented in an operating system virtualization environment. Such application containers can interact with the virtualized controllers to access data in the storage pool 370.

The foregoing virtualized controllers can be implemented in the environment of FIG. 3C using various techniques. Specifically, containers (e.g., Docker containers) can be used to implement a virtualized controller at the node. In this case, the user VMs can access the storage pool 370 by interfacing with a controller container through a hypervisor and/or through the kernel of the node's host operating system.

As another virtualized controller implementation example, an instance of a virtual machine at a given node can be used as a virtualized controller to manage storage and I/O (input/output or IO) activities. In this case, the user VMs at the node can interface with a controller virtual machine (e.g., controller VM) through a hypervisor to access the storage pool 370. In such cases, the controller VMs are not formed as part of specific implementations of the hypervisors. Instead, the controller VMs can run as virtual machines above the hypervisors on the various servers. When the controller VMs run above the hypervisors, varying virtual machine architectures and/or hypervisors can operate with the distributed storage system 304. For example, a hypervisor at one node in the distributed storage system 304 might correspond to VMware ESXi software, and a hypervisor at another node in the distributed storage system 304 might correspond to Nutanix AHV software.

In certain embodiments, one or more instances of migration agents can be implemented in the distributed storage system 304 to facilitate the herein disclosed techniques. Specifically, an instance of working set aware migration agent 340_{S} can be installed (at least temporarily) in virtualized controller 336₁, and another instance of working set aware migration agent 340_{T} can be installed in the shown virtualized controller 336_{M}. Instances of the working set aware migration agents can be implemented in any form, in any node, and in any cluster.

In some cases, a migration agent might interact with other components in the distributed storage system 304 to discover and enumerate applications and/or to observe network activity (e.g., port scanning) and/or storage I/O activity (e.g., over named files and/or file access patterns) associated with certain virtualized applications. Specifically, the herein disclosed techniques might facilitate dynamically migrating applications among virtualization environments responsive to network performance. For example, a certain application (e.g., MySQL) might exhibit extensive use (e.g., by numerous users in a large enterprise) so as to induce application performance degradation. In such cases, the application might be automatically migrated from one virtualized environment to another virtualized environment for one or more reasons, such as to improve application performance, and/or to comply with scheduling policies (e.g., to place all container workloads on a particular connected public cloud provider), and/or to observe network or security policy changes, and/or to respond to resource availabilities due to environmental changes, and/or changes to any of a variety of compliance policy statements.

### Data Transmission Using PCI-e and CXL.Memory Hardware

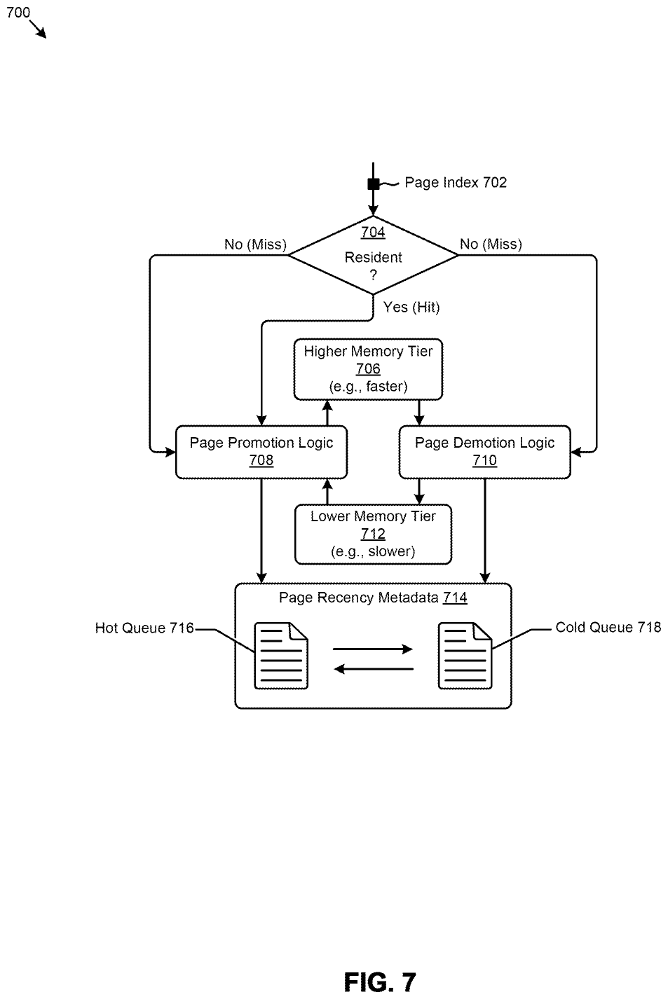

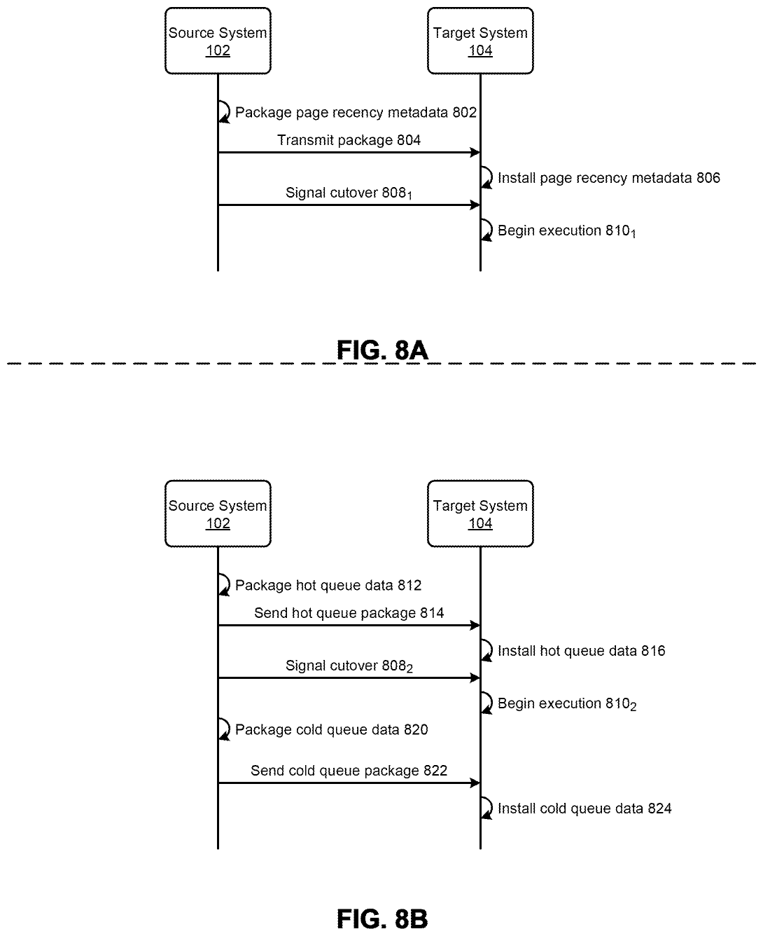

Some deployments of two or more nodes include PCI-e hardware that facilitates high speed remote memory accesses. In such deployments the source and target hosts can both access a common pool of hardware memory (e.g. residing in a separate “memory appliance” or “memory pool” via CXL), however the page recency metadata state is node-specific, and some means for communicating data from a source node to a target node needs to be provided. The following figures show and describe techniques for communicating virtual page data from a source node to a target node (FIG. 4) as well as techniques for communicating page cache recency metadata from a source node to a target node (FIG. 5).

FIG. 4 depicts a page data transmission technique as implemented in systems that handle page cache recency metadata to achieve high performance node-to-node computing entity migration. As an option, one or more variations of page data transmission technique 400 or any aspect thereof may be implemented in the context of the architecture and functionality of the embodiments described herein and/or in any environment.

The figure is being presented to emphasize that there are many possible page data transmission techniques, some of which are most advantageously applied given a certain set of conditions, whereas different page data transmission techniques are most advantageously applied given a different set of conditions. To illustrate, consider the scenario where a virtual machine has a very small executable segment and a very large data segment. During ongoing execution, it might happen that the few virtual pages that comprise the executable segment are very frequently accessed, and therefore deemed to be hot pages, whereas all or nearly all of the individual pages of the very large data segment are very infrequently accessed, and therefore those individual pages are deemed to be cold pages. In this scenario, it would be advantageous to clone the pages of the few virtual pages that comprise the executable segment before copying over the pages of the very large data segment that are very infrequently accessed. In this scenario, cutover of execution to the cloned pages can occur very aggressively, such as for example, immediately after the few virtual pages that comprise the executable segment have been cloned to the target.

The foregoing is merely one example scenario, however there are many other possible scenarios, each of which might have a respective preferred page transmission regime. Accordingly, a library of page data transmission regimes is provided. As a first operation in the shown step 404, a library of page data transmission regimes 402 is queried. A preferred virtual page data transmission regime is returned as query results 405. The preferred data transmission regime is determined based at least in part on a given deployment scenario 403. The preferred data transmission regime includes some means for determining the first virtual page to be transmitted (step 406), a means for transmitting the page (step 408), as well as a means for selecting subsequent pages that correspond to successive next virtual page transmissions (step 410). In some cases, a preferred data transmission regime is dynamic in nature, at least in that determination of a next successive next virtual page transmission is dependent, at least in part, on the then-current conditions.

In some cases, the preferred data transmission regime includes a preferred technology for the transmissions. Strictly as one example, a preferred data transmission regime might specify that PCI-e hardware is to be used for the transmissions.

Communication of page data continues in a loop (e.g., corresponding to the “No” branch of decision 412) until such time as there are no more virtual pages to be cloned from the source node to the target node.

Carrying out the foregoing steps and decisions can take place concurrently with transmissions of page recency metadata. One possible technique for page recency metadata transmission is shown and described as pertains to FIG. 5.

FIG. 5 depicts a page recency metadata transmission technique as implemented in systems that communicate virtual page cache recency metadata state between a source node and a target node. As an option, one or more variations of page recency metadata transmission technique 500 or any aspect thereof may be implemented in the context of the architecture and functionality of the embodiments described herein and/or in any environment.

The figure is being presented to emphasize that there are many possible page recency metadata transmission techniques, some of which are most advantageously applied given a certain set of conditions, whereas different page recency metadata transmission techniques are most advantageously applied given a different set of conditions.

To illustrate, consider the scenario where a virtual machine that has a very small executable segment and a very large data segment. During ongoing execution, it might happen that the few virtual pages that comprise the executable segment are very frequently accessed, and therefore deemed to be hot pages, whereas all or nearly all of the individual pages of the very large data segment are very infrequently accessed, and therefore those individual pages are deemed to be cold pages. In this scenario, it would be advantageous to clone the page recency metadata of the few virtual pages that comprise the executable segment before copying over the page recency metadata of the very large data segment that are very infrequently accessed.

The foregoing is merely one example scenario, however there are many other possible scenarios, each of which might have a respective preferred page recency metadata transmission regime. Accordingly, a library of page recency metadata transmission regimes is provided. As a first operation in the shown step 504, a library of page recency metadata transmission regimes 502 is queried. A preferred transmission regime for virtual page recency metadata is returned as query results 505. The preferred data transmission regime is determined based at least in part on a given deployment scenario 503. The preferred data transmission regime includes some means for determining a representation mode for virtual page recency metadata items (step 506), a means or mode for transmitting the items (step 508), as well as a means for proceeding to successive next transmissions (step 510). In some cases, the preferred data transmission regime is dynamic in nature, at least in that determination of a next successive next page recency metadata transmission (if any) is dependent, at least in part, on the then-current conditions.

In some cases, the preferred data transmission regime includes a preferred technology for the transmissions. Strictly as one example, a preferred data transmission regime might specify that PCI-e hardware is to be used for the transmissions.

Communication of page recency metadata continues in a loop (e.g., corresponding to the “No” branch of decision 512) until such time as there is no more page recency metadata to be cloned from the source node to the target node.

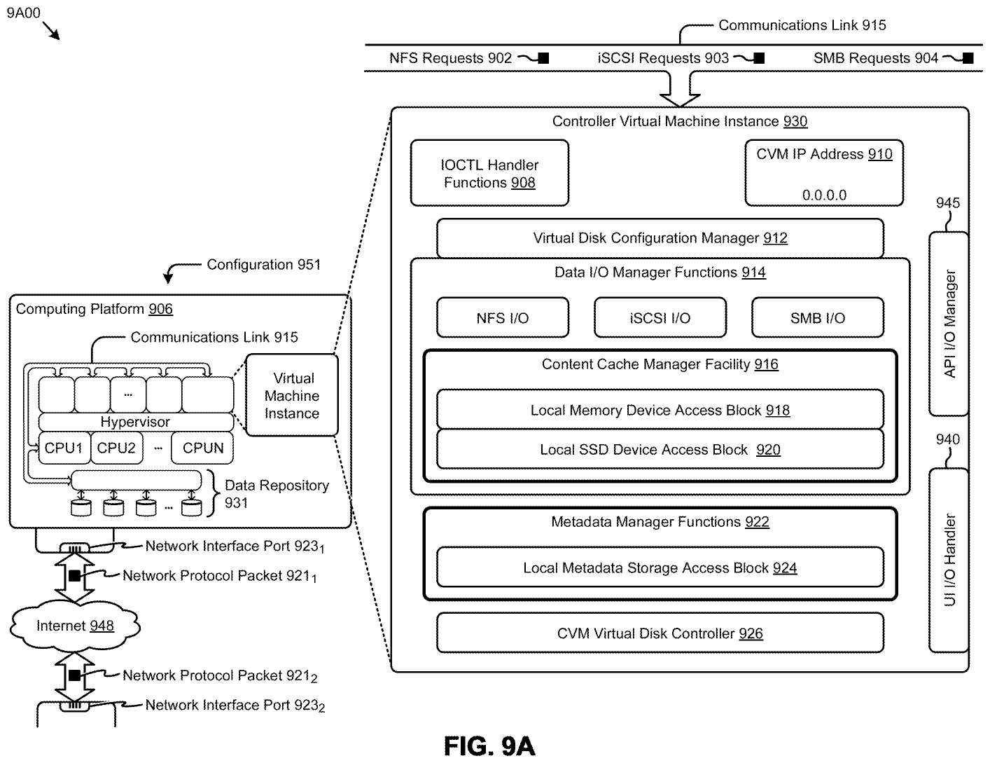

Carrying out the foregoing steps and decisions can take place concurrent with transmissions of virtual page data. Moreover, any of the foregoing data transmission regimes may avail of a wide variety of implementation choices covering communication protocols, data representation, and use of encryption. A selection of example implementation options are presented hereunder as shown and described as pertaining to FIG. 6A, FIG. 6B, and FIG. 6C.

FIG. 6A depicts a page recency metadata communication technique as implemented in systems that communicate a virtual page cache recency metadata state between a source node and a target node. As an option, one or more variations of page recency metadata communication technique 6A00 or any aspect thereof may be implemented in the context of the architecture and functionality of the embodiments described herein and/or in any environment.

As shown, decision 602 selects between multiple techniques, and any one or more of such techniques serves to move page recency metadata from a source node to a target node. The shown push-pull techniques (e.g., push technique 6041 and pull technique 6042) and the shown packaging technique (e.g., push packaging technique 6061 and pull packaging technique 6062) are presented as non-limiting examples.

The foregoing refers to pushing or pulling page recency metadata in the form of a single package or in multiple data structures. In some cases the decision to choose one technique over another technique depends on how the page recency metadata is represented. Various options for how to represent page recency metadata are shown and described in FIG. 6B.

FIG. 6B depicts a page recency metadata representation technique as implemented in systems that communicate virtual page cache recency metadata state between a source node and a target node. As an option, one or more variations of any one or more of the shown page recency metadata representation techniques 6B00 or any aspect thereof may be implemented in the context of the architecture and functionality of the embodiments described herein and/or in any environment.

As is understood by those of skill in the art, page recency information can be represented in many data structures. Strictly to illustrate, page recency metadata can be represented as a vector of individual elements, where each successive element in the vector contains a value that represents the current state of how hot (or cold) a page is. It can be understood by the communication protocol that the first element in the vector (e.g., element at index=0) contains the value for virtual page (or page frame)=0, the second element in the vector (e.g., element at index=1) contains the value for virtual page (or page frame)=1, and so on.

As shown, decision 608 selects between (1) a native representation (selection 610), (2) a representation as a compressed package (selection 612), or (3) a representation using individual element encoding (selection 614).

### Linux Representation Example

In some cases, the selected representation (e.g., format) of page recency depends on how the OS or hypervisor implementations themselves track recency. For example, in the case of traditional Linux “active” and “inactive” LRU lists, a single bit could be used to represent which list contains a page. For a system using MGLRU, a small integer could be used to represent which MGLRU list contains a page. Optionally, an additional integer could be used to represent either the exact position of the page within that list, or some quantized representation, such as its percentile. As another example, if a system tracks page recency using a timestamp, then the timestamp would be included in the per-page metadata.

As another Linux-based example, a QEMU user space process that implements live migration would first obtain the page recency metadata for the given guest on the source host. It would then serialize this metadata and send it to a corresponding QEMU process on the target host, which would then use it to establish per-page recency settings on the target host.

The existing “active” and “inactive” LRU lists employed by Linux aren't exposed to the user space applications. However, QEMU could operate on the “pagemap” interface to determine if the given page frame is mapped to the guest's address space or not, and then apply the corresponding “madvise( )” call with the “MADV_COLD” or “MADV_PAGEOUT” flags.

The MGLRU technique provides a “debugfs” interface to retrieve the page recency metadata. This interface is available to user space applications. QEMU can supply another user space interface to apply the metadata on the target host. One possible implementation relies on the “madvise( )” call that uses numeric parameters to express an ordinal position of the given address range in the MGLRU lists.

Additionally, QEMU could implement various placement optimizations based on the processing of the page recency metadata. For instance, on a target host using tiered memory, (e.g., equipped with both DRAM and PMEM), it could place colder pages in slower PMEM.

Further details regarding general approaches to managing and maintaining tiered memories are described in U.S. Patent Application Publication No. 2022/0229774 titled “JUST-IN-TIME VIRTUAL PER-VM SWAP SPACE” published on Jul. 21, 2022, which is hereby incorporated by reference in its entirety.

FIG. 6C depicts a third page recency metadata encryption type selection technique as implemented in systems that communicate virtual page cache recency metadata state between a source node and a target node. As an option, one or more variations of page recency metadata encryption type selection technique 6C00 or any aspect thereof may be implemented in the context of the architecture and functionality of the embodiments described herein and/or in any environment.

### Encryption

In some cases, the contents of a page are encrypted before sending to the target machine. In this case, if the page contents are indeed being encrypted, which depends at least in part on the implementation/configuration, then the page recency metadata might also be encrypted. This is because, while the page recency metadata might be less sensitive and/or subject to misappropriation than the data itself, communication of the unencrypted page recency metadata runs the risk of leaking information that could potentially be used to mount side-channel attacks.

As shown, decision 616 selects between (1) no encryption (selection 618), (2) encryption using form #1 (selection 620), or (3) encryption using form #2 (selection 622).

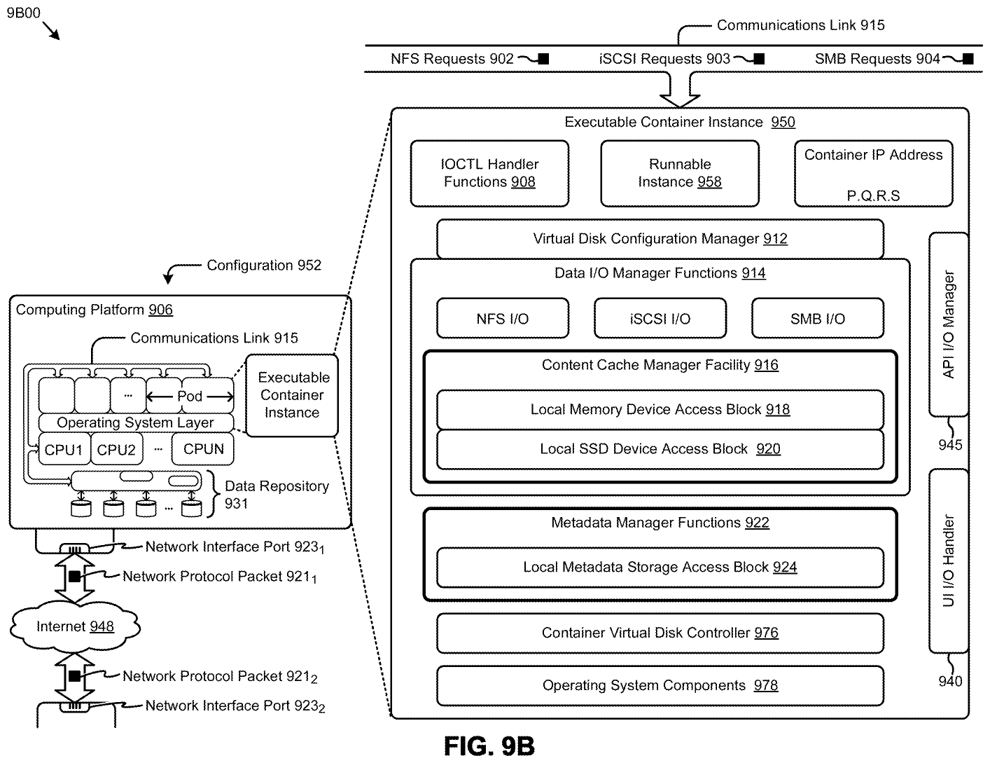

FIG. 7 depicts a selection of queue management functions as used in a caching subsystem. As an option, one or more variations of caching subsystem 700 or any aspect thereof may be implemented in the context of the architecture and functionality of the embodiments described herein and/or in any environment.

The figure is being presented to illustrate one way that page recency metadata can be generated. More specifically, the figure is being presented to illustrate one way that page recency metadata can be updated based on page promotion logic and/or page demotion logic.

The figure depicts a portion of a lifecycle of a page index (or page frame specification). The show portion of the lifecycle begins when a page index 702 (or page frame specification) is received at decision 704. Decision 704 determines whether or not the data of the referenced page is already resident in the cache subsystem data structures. If so (e.g., a cache “hit”), then page promotion logic 708 is invoked (e.g., by taking the “Yes” branch of decision 704) such that page recency metadata 714 can be updated to reflect the occurrence of the page reference. Appropriate modifications are made to the hot queue 716 and/or to the cold queue 718.

On the other hand, if the data of the referenced page is not known to be already resident in the cache subsystem data structures (e.g., by taking the left “No (Miss)” branch of decision 704), then both page promotion logic 708 and page demotion logic 710 are invoked. In this case, invocation of the page promotion logic serves to move the page data from a lower memory tier 712 to a higher memory tier 706. Furthermore, in this case, invocation of the page demotion logic (e.g., by taking the right “No (Miss)” branch of decision 704), serves to move the page data from a higher memory tier 706 to a lower memory tier 712. Appropriate modifications are made to the hot queue 716 and/or to the cold queue 718.

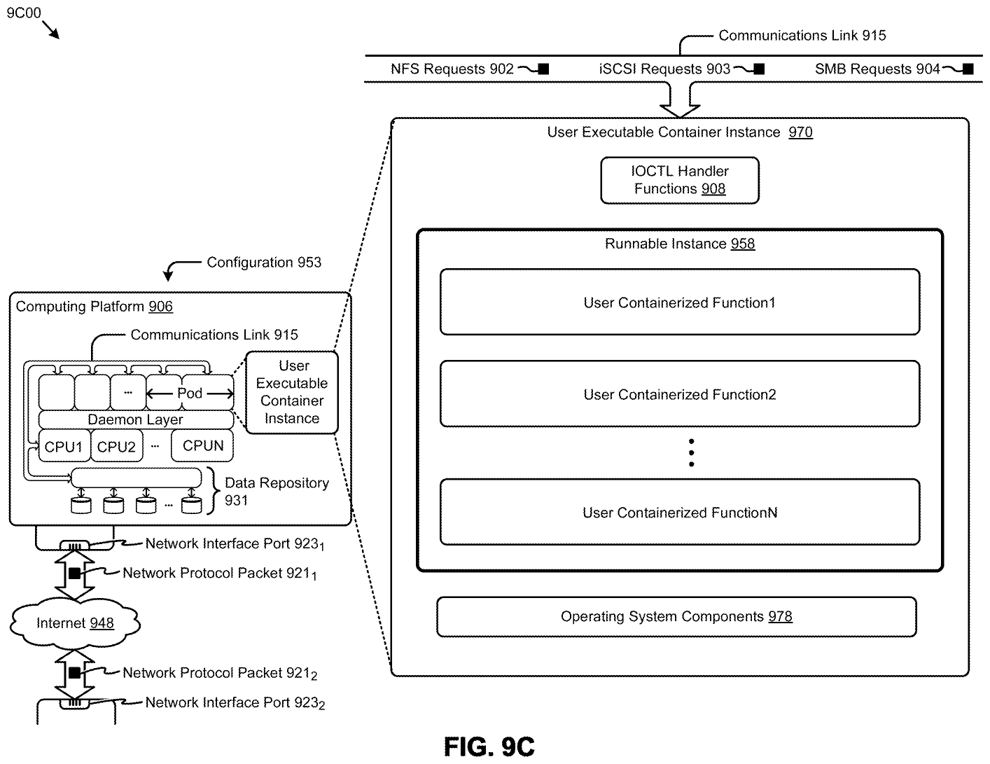

FIG. 8A and FIG. 8B depict alternative page recency transfer protocols. As an option, one or more variations of page recency transfer protocols or any aspect thereof may be implemented in the context of the architecture and functionality of the embodiments described herein and/or in any environment.

The shown protocol exchanges of FIG. 8A and FIG. 8B are being presented to illustrate alternative protocols for communicating page recency metadata from a source system 102 to a target system 104, and then and installing the page recency metadata into the target system.

In FIG. 8A, an extent of page recency metadata (e.g., page recency metadata for a particular process at source system 102) is packaged using any of the foregoing representation techniques or alternatives (operation 802). The package containing page recency metadata is transmitted to the target system 104 (message 804). The target system receives the contents of message 804 and installs the received page recency metadata (operation 806) into page recency metadata structures of the target system. In this example protocol, a computing process that is either part of, or integrated with, the source system is able to signal appropriateness of a cutover (message 808₁), whereafter the target system can begin execution (operation 810₁) of the subject process corresponding to the page recency metadata. In some cases, the target system is able to begin execution of the subject process even before all pages of a subject process have been communicated from the source system to the target system. In some cases, the target system initiates one or more further protocols during execution of the subject process. For example, the target system might initiate a protocol under which the source system is advised that it can destroy data structures that were allocated by or on behalf of the now-migrated process.

FIG. 8B illustrates the case where page recency metadata is embodied in a hot queue and a cold queue. The aforementioned hot and a cold queues might actually be multiple hot queues and multiple cold queues, possibly also including references to additional page recency metadata. As shown, the source system 102 packages the hot queue into a package (operation 812), then sends the package (message 814) to the target system 104. The target system receives and interprets the package and installs hot queue data into the hot queue(s) and/or other data structures of the target system (operation 816). At this point in time, the source system can send a signal to cut over (message 808₂) such that the target system can begin executing the subject process (operation 810₂). At this point in time the target system has enough information (e.g., the hot queue data) such that the target system is at least aware of the set of hot pages that should not be the first candidates for eviction under memory pressure conditions.

As can be seen from the foregoing, the source node can determine when to send a signal to cut over. Accordingly, the foregoing protocols and/or variations thereof can be used in both pre-copy migration scenarios as well as post-copy scenarios.

In a further protocol phase, steps are carried out to package the cold queue data of the source system (operation 820) and communicate the package to the target system (message 822) such that the target system can install the cold queue data (operation 824).

### System Architecture Overview

### Additional System Architecture Examples

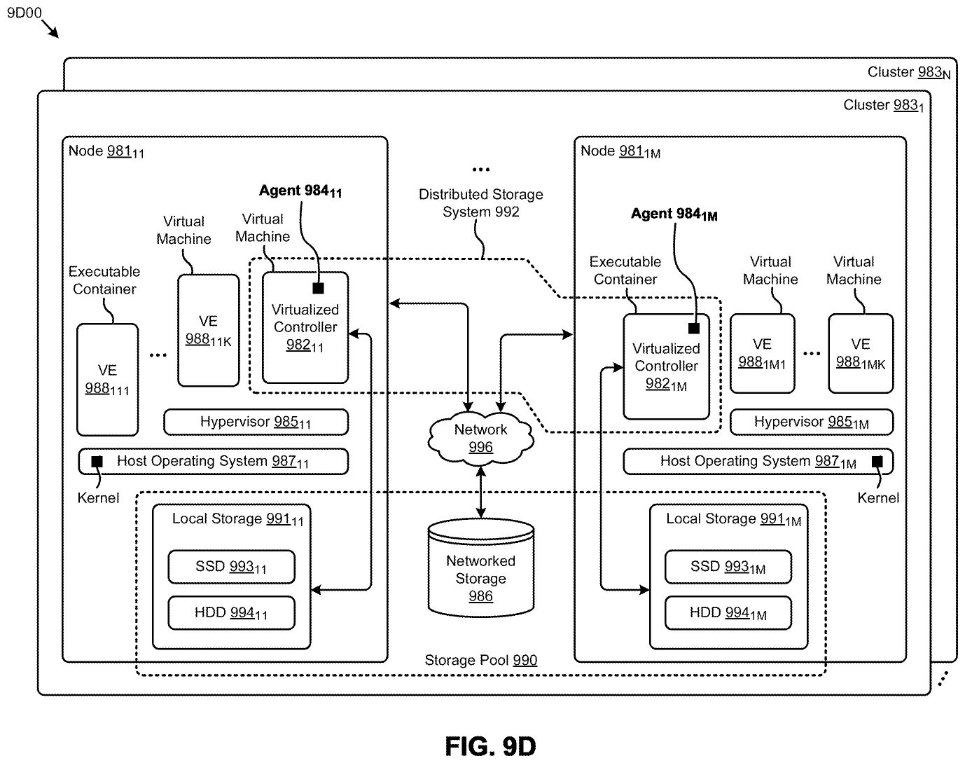

All or portions of any of the foregoing techniques can be partitioned into one or more modules and instanced within, or as, or in conjunction with, a virtualized controller in a virtual computing environment. Some example instances of virtualized controllers situated within various virtual computing environments are shown and discussed as pertains to FIG. 9A, FIG. 9B, FIG. 9C, and FIG. 9D.

FIG. 9A depicts a virtualized controller as implemented in the shown virtual machine architecture 9A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as a layer in a hypervisor). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 9A00 comprises a collection of interconnected components suitable for implementing embodiments of the present disclosure and/or for use in the herein-described environments. Moreover, virtual machine architecture 9A00 includes a virtual machine instance in configuration 951 that is further described as pertaining to controller virtual machine instance 930. Configuration 951 supports virtual machine instances that are deployed as user virtual machines, or controller virtual machines or both. Such virtual machines interface with a hypervisor (as shown). Some virtual machines are configured for processing of storage inputs or outputs (I/O or IO) as received from any or every source within the computing platform. An example implementation of such a virtual machine that processes storage I/O is depicted as 930.

In this and other configurations, a controller virtual machine instance receives block I/O storage requests as network file system (NFS) requests in the form of NFS requests 902, and/or internet small computer system interface (iSCSI) block IO requests in the form of iSCSI requests 903, and/or Samba file system (SMB) requests in the form of SMB requests 904. The controller virtual machine (CVM) instance publishes and responds to an internet protocol (IP) address (e.g., CVM IP address 910). Various forms of input and output can be handled by one or more IO control (IOCTL) handler functions (e.g., IOCTL handler functions 908) that interface to other functions such as data IO manager functions 914 and/or metadata manager functions 922. As shown, the data IO manager functions can include communication with virtual disk configuration manager 912 and/or can include direct or indirect communication with any of various block IO functions (e.g., NFS TO, iSCSI IO, SMB TO, etc.).

In addition to block IO functions, configuration 951 supports input or output (TO) of any form (e.g., block TO, streaming IO) and/or packet-based IO such as hypertext transport protocol (HTTP) traffic, etc., through either or both of a user interface (UI) handler such as UI IO handler 940 and/or through any of a range of application programming interfaces (APIs), possibly through API IO manager 945.

Communications link 915 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, controller virtual machine instance 930 includes content cache manager facility 916 that accesses storage locations, possibly including local dynamic random access memory (DRAM) (e.g., through local memory device access block 918) and/or possibly including accesses to local solid state storage (e.g., through local SSD device access block 920).

Common forms of computer readable media include any non-transitory computer readable medium, for example, floppy disk, flexible disk, hard disk, magnetic tape, or any other magnetic medium; compact disk read-only memory (CD-ROM) or any other optical medium; punch cards, paper tape, or any other physical medium with patterns of holes; or any random access memory (RAM), programmable read-only memory (PROM), erasable programmable read-only memory (EPROM), flash memory EPROM (FLASH-EPROM), or any other memory chip or cartridge. Any data can be stored, for example, in any form of data repository 931, which in turn can be formatted into any one or more storage areas, and which can comprise parameterized storage accessible by a key (e.g., a filename, a table name, a block address, an offset address, etc.). Data repository 931 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 924. The data repository 931 can be configured using CVM virtual disk controller 926, which can in turn manage any number or any configuration of virtual disks.

Execution of a sequence of instructions to practice certain embodiments of the disclosure are performed by one or more instances of a software instruction processor, or a processing element such as a central processing unit (CPU) or data processor or graphics processing unit (GPU), or such as any type or instance of a processor (e.g., CPU1, CPU2, . . . , CPUN). According to certain embodiments of the disclosure, two or more instances of configuration 951 can be coupled by communications link 915 (e.g., backplane, local area network, public switched telephone network, wired or wireless network, etc.) and each instance may perform respective portions of sequences of instructions as may be required to practice embodiments of the disclosure.

The shown computing platform 906 is interconnected to the Internet 948 through one or more network interface ports (e.g., network interface port 9231 and network interface port 9232). Configuration 951 can be addressed through one or more network interface ports using an IP address. Any operational element within computing platform 906 can perform sending and receiving operations using any of a range of network protocols, possibly including network protocols that send and receive packets (e.g., network protocol packet 9211 and network protocol packet 9212).

Computing platform 906 may transmit and receive messages that can be composed of configuration data and/or any other forms of data and/or instructions organized into a data structure (e.g., communications packets). In some cases, the data structure includes program instructions (e.g., application code) communicated through the Internet 948 and/or through any one or more instances of communications link 915. Received program instructions may be processed and/or executed by a CPU as it is received and/or program instructions may be stored in any volatile or non-volatile storage for later execution. Program instructions can be transmitted via an upload (e.g., an upload from an access device over the Internet 948 to computing platform 906). Further, program instructions and/or the results of executing program instructions can be delivered to a particular user via a download (e.g., a download from computing platform 906 over the Internet 948 to an access device).

Configuration 951 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (LAN) and/or through a virtual LAN (VLAN) and/or over a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to cloning of virtual page cache recency metadata state to achieve high performance node-to-node process migration. In some embodiments, a module may include one or more state machines and/or combinational logic used to implement or facilitate the operational and/or performance characteristics pertaining to handling of virtual page cache recency metadata to achieve high performance node-to-node process migration.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate cloning of a virtual page cache recency metadata state to achieve high performance node-to-node process migration). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is using virtual page cache recency metadata.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 9B depicts a virtualized controller implemented by containerized architecture 9B00. The containerized architecture comprises a collection of interconnected components suitable for implementing embodiments of the present disclosure and/or for use in the herein-described environments. Moreover, the shown containerized architecture 9B00 includes an executable container instance in configuration 952 that is further described as pertaining to executable container instance 950. Configuration 952 includes an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification, possibly including the hypertext transport protocol (HTTP or “http:”) and/or possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

The operating system layer can perform port forwarding to any executable container (e.g., executable container instance 950). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “ls”, “dir”, etc.). The executable container might optionally include operating system components 978, however such a separate set of operating system components need not be provided. As an alternative, an executable container can include runnable instance 958, which is built (e.g., through compilation and linking, or just-in-time compilation, etc.) to include any or all of any or all library entries and/or operating system (OS) functions, and/or OS-like functions as may be needed for execution of the runnable instance. In some cases, a runnable instance can be built with a virtual disk configuration manager, any of a variety of data IO management functions, etc. In some cases, a runnable instance includes code for, and access to, container virtual disk controller 976. Such a container virtual disk controller can perform any of the functions that the aforementioned CVM virtual disk controller 926 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 9C depicts a virtualized controller implemented by a daemon-assisted containerized architecture 9C00. The containerized architecture comprises a collection of interconnected components suitable for implementing embodiments of the present disclosure and/or for use in the herein-described environments. Moreover, the shown daemon-assisted containerized architecture includes a user executable container instance in configuration 953 that is further described as pertaining to user executable container instance 970. Configuration 953 includes a daemon layer (as shown) that performs certain functions of an operating system.

User executable container instance 970 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 958). In some cases, the shown operating system components 978 comprise portions of an operating system, which portions are interfaced with or included in the runnable instance and/or any user containerized functions. In this embodiment of a daemon-assisted containerized architecture, the computing platform 906 might or might not host operating system components other than operating system components 978. More specifically, the shown daemon might or might not host operating system components other than operating system components 978 of user executable container instance 970.

The virtual machine architecture 9A00 of FIG. 9A and/or the containerized architecture 9B00 of FIG. 9B and/or the daemon-assisted containerized architecture 9C00 of FIG. 9C can be used in any combination to implement a distributed platform that contains multiple servers and/or nodes that manage multiple tiers of storage where the tiers of storage might be formed using the shown data repository 931 and/or any forms of network accessible storage. As such, the multiple tiers of storage may include storage that is accessible over communications link 915. Such network accessible storage may include cloud storage or networked storage (NAS) and/or may include all or portions of a storage area network (SAN). Unlike prior approaches, the presently discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 951 of FIG. 9A) to manage the interactions between the underlying hardware and user virtual machines or containers that run client software.

Distinct from user virtual machines or user executable containers, a special controller virtual machine (e.g., as depicted by controller virtual machine instance 930) or as a special controller executable container is used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 9D depicts a distributed virtualization system in a multi-cluster environment 9D00. The shown distributed virtualization system is configured to be used to implement the herein disclosed techniques. Specifically, the distributed virtualization system of FIG. 9D comprises multiple clusters (e.g., cluster 983₁, . . . , cluster 983_{N}) comprising multiple nodes that have multiple tiers of storage in a storage pool. Representative nodes (e.g., node 981₁₁, . . . , node 981_{1M}) and storage pool 990 associated with cluster 9831 are shown. Each node can be associated with one server, multiple servers, or portions of a server. The nodes can be associated (e.g., logically and/or physically) with the clusters. As shown, the multiple tiers of storage include storage that is accessible through a network 996, such as a networked storage 986 (e.g., a storage area network or SAN, network attached storage or NAS, etc.). The multiple tiers of storage further include instances of local storage (e.g., local storage 991₁₁, . . . , local storage 991_{1M}). For example, the local storage can be within or directly attached to a server and/or appliance associated with the nodes. Such local storage can include solid state drives (SSD 993₁₁, . . . , SSD 993_{1M}), hard disk drives (HDD 994₁₁, . . . , HDD 994_{1M}), and/or other storage devices.

As shown, any of the nodes of the distributed virtualization system can implement one or more user virtualized entities (VEs) such as the virtualized entity (VE) instances shown as VE 988₁₁₁, . . . , VE 988_{11K}, . . . , VE 988_{1M1}, . . . , VE 988_{1MK}, and/or a distributed virtualization system can implement one or more virtualized entities that may be embodied as a virtual machines (VM) and/or as an executable container. The VEs can be characterized as software-based computing “machines” implemented in a container-based or hypervisor-assisted virtualization environment that emulates underlying hardware resources (e.g., CPU, memory, etc.) of the nodes. For example, multiple VMs can operate on one physical machine (e.g., node host computer) running a single host operating system (e.g., host operating system 987₁₁, . . . , host operating system 987_{1M}), while the VMs run multiple applications on various respective guest operating systems. Such flexibility can be facilitated at least in part by a hypervisor (e.g., hypervisor 985₁₁, . . . , hypervisor 985_{1M}), which hypervisor is logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers comprise groups of processes and/or may use resources (e.g., memory, CPU, disk, etc.) that are isolated from the node host computer and other containers. Such executable containers directly interface with the kernel of the host operating system (e.g., host operating system 987₁₁, . . . , host operating system 987_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 990 by the VMs and/or the executable containers.

Multiple instances of such virtualized controllers can coordinate within a cluster to form the distributed storage system 992 which can, among other operations, manage the storage pool 990. This architecture further facilitates efficient scaling in multiple dimensions (e.g., in a dimension of computing power, in a dimension of storage space, in a dimension of network bandwidth, etc.).

A particularly configured instance of a virtual machine at a given node can be used as a virtualized controller in a hypervisor-assisted virtualization environment to manage storage and I/O (input/output or IO) activities of any number or form of virtualized entities. For example, the virtualized entities at node 981₁₁ can interface with a controller virtual machine (e.g., virtualized controller 982₁₁) through hypervisor 985₁₁ to access data of storage pool 990. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 992. For example, a hypervisor at one node in the distributed storage system 992 might correspond to software from a first vendor, and a hypervisor at another node in the distributed storage system 992 might correspond to a second software vendor. As another virtualized controller implementation example, executable containers can be used to implement a virtualized controller (e.g., virtualized controller 982_{1M}) in an operating system virtualization environment at a given node. In this case, for example, the virtualized entities at node 981_{1M} can access the storage pool 990 by interfacing with a controller container (e.g., virtualized controller 982_{1M}) through hypervisor 985_{1M} and/or the kernel of host operating system 987_{1M}.

In certain embodiments, one or more instances of an agent can be implemented in the distributed storage system 992 to facilitate the herein disclosed techniques. Specifically, agent 984₁₁ can be implemented in the virtualized controller 982₁₁, and agent 984_{1M} can be implemented in the virtualized controller 982_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to transferring page recency metadata from a source node to a target node can be brought to bear through implementation of any one or more of the foregoing techniques. Moreover, any aspect or aspects of achieving high performance node-to-node migrations can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A non-transitory computer readable medium having stored thereon a sequence of instructions which, when stored in memory and executed by a processor cause the processor to perform acts comprising:
receiving a request to migrate a computing process from a first computing node to a second computing node; and
responding to a request to migrate a computing process from a first computing node to a second computing node by:
copying contents of one or more pages of the computing process from the first node to the second computing node;
identifying page recency metadata corresponding to the one or more pages of the computing process; and
copying at least a portion of the identified page recency metadata to the second computing node.

2. The non-transitory computer readable medium of claim 1, further comprising instructions which, when stored in memory and executed by the processor cause the processor to perform further acts of, accessing, by a CPU of the second computing node, at least some of the pages of the computing process, wherein the CPU of the second computing node observes the page recency metadata that is stored at the second computing node.

3. The non-transitory computer readable medium of claim 1, wherein the at least a portion of the identified page recency metadata is stored in a first representation and further comprising instructions which, when stored in memory and executed by the processor cause the processor to perform further acts of converting the at least a portion of the identified page recency metadata into a second representation.

4. The non-transitory computer readable medium of claim 3, wherein the at least a portion of the identified page recency metadata in the second representation is encrypted before initiating the copying of at least a portion of the identified page recency metadata to the second computing node.

5. The non-transitory computer readable medium of claim 1, wherein a first portion of the identified page recency metadata is transmitted to the second computing node before transmitting a second portion of the identified page recency metadata.

6. The non-transitory computer readable medium of claim 1, wherein transmissions of one or more subsets of the identified page recency metadata are interleaved in between transmissions of the contents of the one or more pages of the computing process.

7. The non-transitory computer readable medium of claim 1, wherein the computing process comprises at least one of, a virtual machine, a guest operating system, or an executable container.

8. The non-transitory computer readable medium of claim 1, wherein the page recency metadata is derived from most recent page access information, and/or from page access frequency information or by operation of at least one of, a least recently used algorithm, a least frequently used algorithm, an adaptive replacement cache algorithm, a low inter-reference recency set replacement algorithm, or a least recently/frequently used algorithm.

9. A method comprising:
receiving a request to migrate a computing process from a first computing node to a second computing node; and
responding to a request to migrate a computing process from a first computing node to a second computing node by:
copying contents of one or more pages of the computing process from the first node to the second computing node;
identifying page recency metadata corresponding to the one or more pages of the computing process; and
copying at least a portion of the identified page recency metadata to the second computing node.

10. The method of claim 9, further comprising, accessing, by a CPU of the second computing node, at least some of the pages of the computing process, wherein the CPU of the second computing node observes the page recency metadata that is stored at the second computing node.

11. The method of claim 9, wherein the at least a portion of the identified page recency metadata is stored in a first representation and further comprising converting the at least a portion of the identified page recency metadata into a second representation.

12. The method of claim 11, wherein the at least a portion of the identified page recency metadata in the second representation is encrypted before initiating the copying of at least a portion of the identified page recency metadata to the second computing node.

13. The method of claim 9, wherein a first portion of the identified page recency metadata is transmitted to the second computing node before transmitting a second portion of the identified page recency metadata.

14. The method of claim 9, wherein transmissions of one or more subsets of the identified page recency metadata are interleaved in between transmissions of the contents of the one or more pages of the computing process.

15. The method of claim 9, wherein the computing process comprises at least one of, a virtual machine, a guest operating system, or an executable container.

16. The method of claim 9, wherein the page recency metadata is derived from most recent page access information, and/or from page access frequency information or by operation of at least one of, a least recently used algorithm, a least frequently used algorithm, an adaptive replacement cache algorithm, a low inter-reference recency set replacement algorithm, or a least recently/frequently used algorithm.

17. A system comprising:
a storage medium having stored thereon a sequence of instructions; and
a processor that executes the sequence of instructions to cause the processor to perform acts comprising,
receiving a request to migrate a computing process from a first computing node to a second computing node; and
responding to a request to migrate a computing process from a first computing node to a second computing node by:
copying contents of one or more pages of the computing process from the first node to the second computing node;
identifying page recency metadata corresponding to the one or more pages of the computing process; and
copying at least a portion of the identified page recency metadata to the second computing node.

18. The system of claim 17, further comprising instructions which, when stored in memory and executed by the processor cause the processor to perform further acts of, accessing, by a CPU of the second computing node, at least some of the pages of the computing process, wherein the CPU of the second computing node observes the page recency metadata that is stored at the second computing node.

19. The system of claim 17, wherein the at least a portion of the identified page recency metadata is stored in a first representation and further comprising instructions which, when stored in memory and executed by the processor cause the processor to perform further acts of converting the at least a portion of the identified page recency metadata into a second representation.

20. The system of claim 19, wherein the at least a portion of the identified page recency metadata in the second representation is encrypted before initiating the copying of at least a portion of the identified page recency metadata to the second computing node.

21. The system of claim 17, wherein a first portion of the identified page recency metadata is transmitted to the second computing node before transmitting a second portion of the identified page recency metadata.

22. The system of claim 17, wherein transmissions of one or more subsets of the identified page recency metadata are interleaved in between transmissions of the contents of the one or more pages of the computing process.

23. The system of claim 17, wherein the computing process comprises at least one of, a virtual machine, a guest operating system, or an executable container.

24. The system of claim 17, wherein the page recency metadata is derived from most recent page access information, and/or from page access frequency information or by operation of at least one of, a least recently used algorithm, a least frequently used algorithm, an adaptive replacement cache algorithm, a low inter-reference recency set replacement algorithm, or a least recently/frequently used algorithm.
